(19) United States
(12) Patent Application Publication
(10) Pub. No.: US 2011/0082036 A1
(43) Pub. Date: Apr. 7, 2011

(54) Active Compound Combinations Comprising Arylamidines and N-Cycloalkylamides

(76) Inventors: Philippe Desbordes, Lyon (FR); Jean-Pierre Vors, Sainte Foy les Lyon (FR); Benoit Hartmann, Sainte Foy les Lyon (FR); Christophe Dubost, Lyon (FR); Ralf Dunkel, Leichlingen-Krahwinkel (DE); Arounarith Tuch, Lyon (FR); Kerstin Ilg, Koln (DE); Jörg Nico Greul, Leichlingen (DE); Stefan Hillebrand, Neuss (DE); Klaus Kunz, Dusseldorf (DE); Wahed Ahmed Moradi, Monheim (DE); Thomas Seitz, Langenfeld (DE); Peter Dahmen, Neuss (DE); Stephanie Gary, Champagne au Mont d'Or (FR)

(21) Appl. No.: 12/574,889

(22) Filed: Oct. 7, 2009

(51) Int. Cl. A01N 43/56; A01N 55/10; A01N 43/40; A01N 43/82; A01N 43/54; A01N 43/80; A01C 1/06

(52) U.S. Cl. 504/100; 514/406; 514/63; 514/341; 514/361; 514/269; 514/372; 514/331

(57) ABSTRACT

The invention relates to active compound combinations comprising (A) an arylamidine compound of formula (I) and a N-cycloalkylamide compound (B) of formula (II). Moreover, the invention relates to a fungicidal composition comprising the compound combinations according to the present invention, to a method for curatively or preventively controlling phytopathogenic fungi, to the use of a combination according to the invention for the treatment of seed, to a method for protecting a seed and to the treated seed itselfs.

The invention relates to active compound combinations comprising (A) an arylamidine compound of formula (I) and a N-cycloalkylamide compound (B) of formula (II). Moreover, the invention relates to a fungicidal composition comprising the compound combinations according to the present invention, to a method for curatively or preventively controlling phytopathogenic fungi, to the use of a combination according to the invention for the treatment of seed, to a method for protecting a seed and to the treated seed itselfs.

N-cycloalkylamides, their preparation from commercially available materials and their use as fungicides is disclosed in WO 2006/120224, WO 2007/087906, WO 2008/015189, WO 2008/037789, WO 2009/016218, WO 2009/016219, WO 2009/016220, WO 2009/016221 and WO 2009/016222.

WO 00/046184 and WO 03/093224, WO 2007/031508, WO 2007/031512, WO 2007/031513, WO 2007/031523, WO 2007/031524, WO 2007/093227, WO 2007/031526 each disclose the use of arylamidines as fungicides and their preparation starting from commercially available materials. WO 03/024219 discloses fungicide combinations comprising at least one phenylarylamidine and at least one further known active ingredient. WO 05/089547 and WO 05/120234 each disclose fungicide combinations comprising at least one phenylamidine and at least one further known fungicidally active ingredient.

The environmental and economic requirements imposed on modern-day fungicides are continually increasing, with regard, for example, to the spectrum of action, toxicity, selectivity, application rate, formation of residues, and favourable preparation ability. Moreover, there may be problems, for example, with resistances.

Therefore, it is a constant task to develop new fungicide combinations which in some areas at least have advantages over their known counterparts.

The problem has been solved according to the present invention by active compound combinations of claim 1. The invention provides active compound combinations/compositions which in some aspects at least achieve the stated objectives.

It has now been found, surprisingly, that the combinations according to the invention not only bring about the additive enhancement of the spectrum of action with respect to the phytopathogen to be controlled that was in principle to be expected but achieves a synergistic effect which extends the range of action of the component (A) and of the component (B) in two ways. Firstly, the rates of application of the component (A) and of the component (B) are lowered whilst the action remains equally good. Secondly, the combination still achieves a high degree of phytopathogen control even where the two individual compounds have become totally ineffective in such a low application rate range. This allows, on the one hand, a substantial broadening of the spectrum of phytopathogens that can be controlled and, on the other hand, increased safety in use. However, besides the actual synergistic action with respect to fungicidal activity, the pesticidal combinations according to the invention also have further surprising advantageous properties which can also be described, in a wider sense, as synergistic activity. Examples of such advantageous properties that may be mentioned are: a broadening of the spectrum of fungicidal activity to other phytopathogens, for example to resistant strains; a reduction in the rate of application of the active ingredients; adequate pest control with the aid of the compositions according to the invention, even at a rate of application at which the individual compounds are totally ineffective; advantageous behaviour during formulation or upon application, for example upon grinding, sieving, emulsifying, dissolving or dispensing; increased storage stability; improved stability to light; more advantageous degradability; improved toxicological or ecotoxicological behaviour; improved characteristics of the useful plants including: emergence, crop yields, more developed root system, tillering increase, increase in plant height, bigger leaf blade, less dead basal leaves, stronger tillers, greener leaf color, less fertilizers needed, less seeds needed, more productive tillers, earlier flowering, early grain maturity, less plant verse (lodging), increased shoot growth, improved plant vigor, and early germination; or any other advantages familiar to a person skilled in the art.

The combination according to the invention can also provide an improved systemicity to the active compounds that are used. Indeed, even if some of the used fungicide compounds do not possess any or a satisfying systemicity, within the composition according to the invention these compounds can exhibit such a property. In a similar manner, the combination according to the invention can allow an increased persistence of the fungicide efficacy of the active compounds that are employed. Another advantage of the combination according to the invention relies in that an increased curativity is achievable.

In a first embodiment the present invention relates to a compound combination comprising

(A) an arylamidine derivative of formula (I):

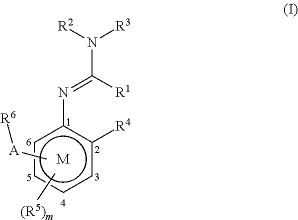

wherein:

R¹ is an alkyl, an alkenyl, an alkynyl, a carbocyclic or heterocyclic monovalent group, it being possible for each of these groups to be substituted, or hydrogen

R², R³ which may be identical or different, are any one of the groups defined for R¹; a cyano; an acyl; —OR^{a} or —SR^{a}, with R^{a} corresponding to an alkyl, an alkenyl, an alkynyl, a carbocyclic or heterocyclic monovalent group, it being possible for each of these groups to be substituted, or R² and R³, or R² and R¹ may form together and with the atoms linking them, a ring which may be substituted;

R⁴ is an alkyl, an alkenyl, an alkynyl, a carbocyclic or heterocyclic monovalent group, it being possible for each of these groups to be substituted, a hydroxyl group; mercapto; azido; nitro; halo; cyano; optionally substituted acyl, amino; cyanato; thiocyanato; —SF₅; —OR^{a}; —SR^{a} or —Si(R^{a})₃;

m is an integer from 0 to 3;

R⁵ which may be mutually identical or different, have the same definition as that given above for R⁴;

R⁶ is optionally substituted with a carbocyclic or hetrocyclic monovalent group; and

A is a direct bond, —O—, —S(O)ₙ—, —NR⁹—, —CR⁷═CR⁷—, —C≡C—, -A¹-, -A¹-A¹, —O-(A¹k-O—, —O-(A¹)ₖ-, -A³-, -A⁴-, -A¹S(O)ₙ—, -A²-, OA²-, —NR⁹A²-, —OA²-A¹-, —OA²-C(R⁷)═C(R⁸)—, —S(O)ₙA¹-, -A¹-A⁴-, -A¹-A⁴-C(R⁸)═N—N═CR⁸—, -A¹-A⁴-C(R⁸)═N—X²—X³—, -A¹-A⁴-A³-, -A¹-A⁴-N(R⁹)-, -A¹-A⁴-X—CH₂—, -A¹-A⁴-A¹-, -A¹-A⁴-CH₂X—, -A¹-A⁴-C(R⁸)═N—X²—X³—X¹—, -A¹-X—C(R⁸)═N—, -A¹-X—C(R⁸)═N—N═CR⁸—, -A¹-X—C(R⁸)═N—N(R⁹)—, -A¹-X-A⁻-X¹—, -A¹-O-A³-, -A¹-O—C(R⁷)═C(R⁸)—, -A¹-O—N(R⁹)-A²-N(R⁹)—, -A¹-O—N(R⁹)-A²-, -A¹ -N(R⁹)-A²-N(R⁹)—, -A¹-N(R⁹)-A²-, -A¹-N(R⁹)—N═C(R⁸)—, -A³-A¹-, -A⁴-A³-, -A²-NR⁹—, -A¹-A²-X¹—, -A¹-A¹-A²-X¹—, —O-A²-N(R⁹)-A²-, —CR⁷═CR⁷-A²-X¹—, —C≡C-A²-X¹—, —N═C(R⁸)-A²-X¹—, —C(R⁸)═N—N═C(R⁸)—, —C(R⁸)═N—N(R⁹), —(CH₂)₂—O—N═C(R⁸)— or —X-A²-N(R⁹)— with

n is 0, 1 or 2,

k is an integer from 1 to 9,

A¹ is —CHR⁷—,

A² is —C(═X)—,

A³ is —C(R⁸)═N—O—,

A⁴ is —O—N═C(R⁸)—,

X is O or S,

X¹ is O, S, NR⁹ or a direct bond,

X² is O, NR⁹ or a direct bond,

X³ is hydrogen, —C(═O)—, —SO₂— or a direct bond,

R⁷ which are mutually identical or different, each correspond to an optionally substituted alkyl, to a cycloalkyl or a phenyl, it being possible for each of these groups to be substituted, hydrogen, a halogen, a cyano, or an acyl;

R⁸ which are mutually identical or different, each correspond to an alkyl, an alkenyl, an alkynyl, an alkoxy, an alkylthio, it being possible for each of these groups to be substituted, a carbocyclic or heterocyclic monovalent group which may be optionally substituted, or hydrogen;

R⁹ which are mutually identical or different, each correspond to an optionally substituted alkyl, to a monovalent carbocyclic or heterocyclic group which may be optionally substituted, or to an acyl; or two R⁹ groups may form together, and with the atoms linking them, a 5-7-membered ring;

the group represented on the right side of the bond A is linked to R⁶; or -A-R⁶ and R⁵ form together with the benzene ring M, a system of optionally substituted condensed rings;

and the optional optical and/or geometric isomers, the tautomers and the addition salts with an acid or a base, which are agriculturally acceptable, of these derivatives of formula (I); and mixtures thereof; and

and

(B) at least one N-cycloalkylamide compound according to formula (II)

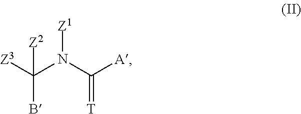

wherein

A′ represents a carbo-linked, unsaturated or partially saturated, 5-membered heterocyclyl group that can be substituted by up to four groups R;

T represents O or S;

Z¹ represents a non-substituted C₃-C₇-cycloalkyl or a C₃-C₇-cycloalkyl substituted by up to 10 atoms or groups that can be the same or different and that can be selected in the list consisting of halogen atoms, cyano, C₁-C₈-alkyl, C₁-C₈-halogenoalkyl comprising up to 9 halogen atoms that can be the same or different, C₁-C₈-alkoxy, C₁-C₈-halogenoalkoxy comprising up to 9 halogen atoms that can be the same or different, C₁-C₈-alkoxycarbonyl, C₁-C₈-halogenoalkoxycarbonyl comprising up to 9 halogen atoms that can be the same or different, C₁-C₈-alkylaminocarbonyl, and di-C₁-C₈-alkylaminocarbonyl;

Z², Z³ which can be the same or different, represent a hydrogen atom; C₁-C₈-alkyl; C₂-C₈-alkenyl; C₂-C₈-alkynyl; cyano; nitro; a halogen atom; C₁-C₈-alkoxy; C₂-C₈-alkenyloxy; C₂-C₈-alkynyloxy; C₃-C₇-cycloalkyl; C₁-C₈-alkylsulphenyl; amino; C₁-C₈-alkylamino; di-C₁-C₈-alkylamine; C₁-C₈-alkoxycarbonyl; C₁-C₈-alkylcarbamoyl; di-C₁-C₈-alkylcarbamoyl; or N-C₁-C₈-alkyl-C₁-C₈-alkoxycarbamoyl, wherein each of these groups may be optionally substituted when chemically possible, or
Z² and Z³ together with the carbon atom to which they are linked form a substituted or non substituted C₃-C₇ cycloalkyl;

B′ represents a phenyl, naphtyl or a 5 to 10-membered monocyclic or fused bicyclic heteroaromatic ring system containing 1 to 3 heteroatoms, each heteroatom is independently selected from oxygen, nitrogen and sulphur; wherein B can be non-, mono- or polysubstituted by X′.

R′ independently represents a hydrogen atom; halogen atom; cyano; nitro; amino; sulfanyl; pentafluoro-λ-6-sulfanyl; C₁-C₈-alkylamino; di-C₁-C₈-alkylamino; tri(C₁-C₈-alkyl)silyl; C₁-C₈-alkylsulfanyl; C₁-C₈-halogenoalkylsulfanyl comprising up to 9 halogen atoms that can be the same or different; C₁-C₈-alkyl; C₁-C₈-halogenoalkyl comprising up to 9 halogen atoms that can be the same or different; C₂-C₈-alkenyl; C₂-C₈-halogenoalkenyl comprising up to 9 halogen atoms that can be the same or different; C₂-C₈-alkynyl; C₂-C₈-halogenoalkynyl comprising up to 9 halogen atoms that can be the same or different; C₁-C₈-alkoxy; C₁-C₈-halogenoalkoxy comprising up to 9 halogen atoms that can be the same or different; C₂ C₈-alkenyloxy; C₂-C₈-alkynyloxy; C₃-C₇-cycloalkyl; C₃-C₇-cycloalkyl-C₁-C₈-alkyl; C₁-C₈-alkylsulphinyl; C₁-C₈-alkylsulphonyl; C₁-C₈alkoxyimino; (C₁-C₈-alkoxyimino)-C₁-C₈-alkyl; (benzyloxyimino)-C₁-C₈-alkyl; phenoxy; benzyloxy; benzylsulfanyl; benzylamino; naphtyl; halogenophenoxy comprising up to 9 halogen atoms that can be the same or different; C₁-C₈-alkylcarbonyl; C₁-C₈-halogenoalkylcarbonyl comprising up to 9 halogen atoms that can be the same or different; C₁-C₈-alkoxycarbonyl; C₁-C₈-halogenoalkoxycarbonyl comprising up to 9 halogen atoms that can be the same or different; C₁-C₈-alkylaminocarbonyl; or di-C₁-C₈-alkylaminocarbonyl, wherein each of these groups may be optionally substituted when chemically possible;

X′ can be the same or different, represents a hydrogen atom; a halogen atom; nitro; cyano; hydroxyl; sulfanyl; amino; pentafluoro-λ6-sulfanyl; C₁-C₈-alkyl; C₁-C₈-halogenoalkyl comprising up to 9 halogen atoms which can be the same or different; C₁-C₈-alkylamino; di-C₁-C₈-alkylamino; C₁-C₈-alkoxy; C₁-C₈-halogenoalkoxy comprising up to 9 halogen atoms which can be the same or different; C₁-C₈-alkoxy-C₁-C₈-alkyl; C₁-C₈-alkylsulfanyl; C₁-C₈-halogenoalkylsulfanyl comprising up to 9 halogen atoms which can be the same or different; C₂-C₈-alkenyl; C₂-C₈-halogenoalkenyl comprising up to 9 halogen atoms which can be the same or different; C₂-C₈-alkynyl; C₂-C₈-halogenoalkynyl comprising up to 9 halogen atoms which can be the same or different C₂-C₈-alkenyloxy; C₂-C₈-halogenoalkenyloxy comprising up to 9 halogen atoms which can be the same or different; C₂-C₈-alkinyloxy; C₂-C₈-halogenoalkinyloxy comprising up to 9 halogen atoms which can be the same or different; C₃-C₇-cycloalkyl; C₃-C₇-cycloalkyl-C₁-C₈-alkyl; C₃-C₇-cycloalkyl-C₁-C₈-alkynyl; C₃-C₇-cycloalkyl-C₁-C₈-alkenyl; C₃-C₇-halogenocycloalkyl comprising up to 9 halogen atoms which can be the same or different; C₃-C₇-cycloalkyl-C₃-C₇-cycloalkyl; C₁-C₈-alkyl-C₃-C₇-cycloalkyl; formyl; formyloxy; formylamino; carboxy; carbamoyl; N-hydroxycarbamoyl; carbamate; (hydroxyimino)-C₁-C₈-alkyl; C₁-C₈-alkylcarbonyl; C₁-C₈-halogenoalkylcarbonyl comprising up to 9 halogen atoms which can be the same or different; C₁-C₈-alkylcarbamoyl; di-C₁-C₈-alkylcarbamoyl; N-C₁-C₈-alkyloxycarbamoyl; C₁-C₈-alkoxycarbamoyl; N-C₁-C₈-alkyl-C₁-C₈-alkoxycarbamoyl; C₁-C₈-alkoxycarbonyl; C₁-C₈-halogenoalkoxycarbonyl comprising up to 9 halogen atoms which can be the same or different; C₁-C₈-alkylaminocarbonyl; di-C₁-C₈-alkylaminocarbonyl; C₁-C₈-alkylcarbonyloxy; C₁-C₈-halogenoalkylcarbonyloxy comprising up to 9 halogen atoms which can be the same or different; C₁-C₈-alkylcarbonylamino; C₁-C₈-halogenoalkylcarbonylamino comprising up to 9 halogen atoms which can be the same or different; C₁-C₈-alkylaminocarbonyloxy; di-C₁-C₈-alkylaminocarbonyloxy; C₁-C₈-alkyloxycarbonyloxy, C₁-C₈-alkylsulphenyl, C₁-C₈-halogenoalkylsulphenyl comprising up to 9 halogen atoms which can be the same or different, C₁-C₈-alkylsulphinyl, C₁-C₈-halogenoalkylsulphinyl comprising up to 9 halogen atoms which can be the same or different, C₁-C₈-alkylsulphonyl, C₁-C₈-halogenoalkylsulphonyl comprising up to 9 halogen atoms which can be the same or different, C₁-C₈-alkoxyimino, (C₁-C₈-alkoxyimino)-C₁-C₈-alkyl, (C₁-C₈-alkenyloxyimino)-C₁-C₈-alkyl, (C₁-C₈-alkynyloxyimino)-C₁-C₈-alkyl, a (benzyloxyimino)-C₁-C₈-alkyl; tri(C₁-C₈-alkyl)silyl; tri(C₁-C₈-alkyl)silyl-C₁-C₈-alkyl; wherein each of these groups may be optionally substituted when chemically possible; benzyloxy which can be substituted by up to 5 groups Q; benzylsulfanyl which can be substituted by up to 5 groups Q; benzylamino which can be substituted by up to 5 groups Q; aryl which can be substituted by up to 6 groups Q; aryloxy which can be substituted by up to 5 groups Q; arylamino which can be substituted by up to 5 groups Q; arylsulfanyl which can be substituted by up to 5 groups Q; aryl-C₁-C₇alkyl which can be substituted by up to 5 groups Q′; aryl-C₁-C₇alkenyl which can be substituted by up to 5 groups Q′; aryl-C₁-C₇alkynyl which can be substituted by up to 5 groups Q′; pyridinyl which can be substituted by up to four groups Q′ or pyridinyloxy which can be substituted by up to four groups Q′; aryl-C₃-C₇cycloalkyl which can be substituted by up to 5 groups Q′; or
Two vicinal substituents R′ together with the consecutive carbon atoms to which they are linked may form a 5- or 6-membered, saturated, carbo- or hetero-cycle comprising up to 3 heteroatoms, which can be substituted by up to four groups Q′ which can be the same or different and the other substituents R′ are as herein-described;

Q′ which can be the same or different, represents a halogen atom; cyano; nitro; C₁-C₈-alkyl; C₁-C₈-alkoxy; C₁-C₈-alkylsulfanyl; C₁-C₈-halogenoalkyl comprising up to 9 halogen atoms which can be the same or different; C₁-C₈-halogenoalkoxy comprising up to 9 halogen atoms which can be the same or different; tri(C₁-C₈)alkylsilyl or tri(C₁-C₈)alkylsilyl-C₁-C₈-alkyl, wherein each of these groups may be optionally substituted when chemically possible;

as well as its salts, N-oxydes, metallic complexes, metalloidic complexes and optically active isomers.

Arylamidine compounds (A) of formula (I) which can be used in conjunction with the present invention are listed in table A below.

TABLE A

| Compd. No. | Structure | Combination with N-cycloakylmide (B) |
|---|---|---|
| A-1 | 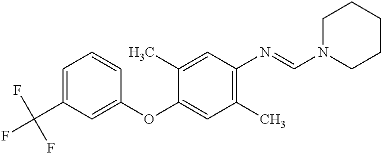 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-2 | 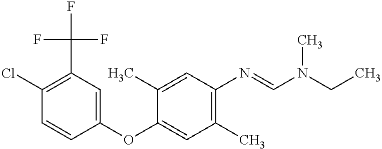 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-3 | 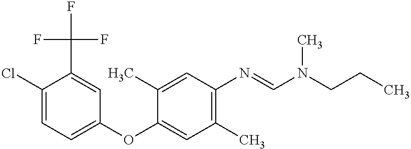 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-4 | 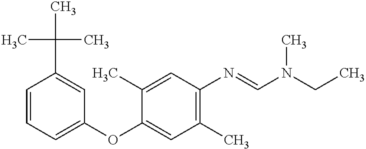 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-5 | 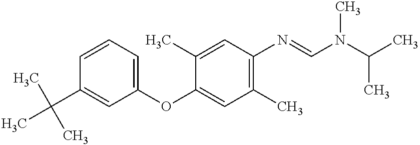 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-6 | 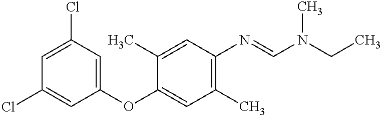 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-7 | 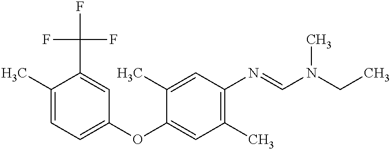 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-8 | 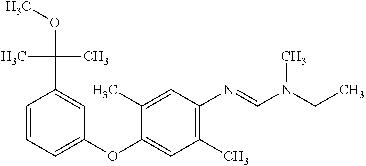 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-9 | 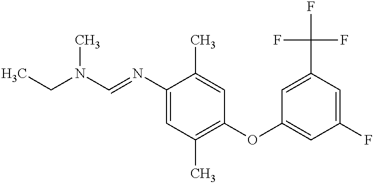 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-10 | 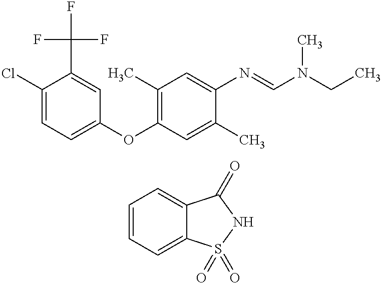 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-11 | 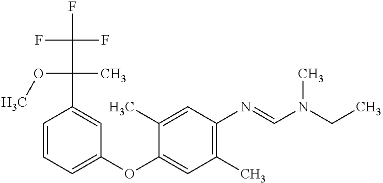 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-12 | 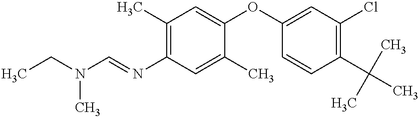 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-13 | 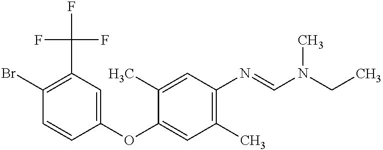 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-14 | 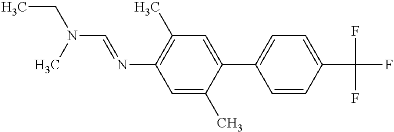 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-15 | 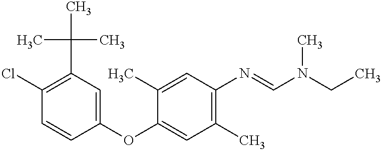 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-16 | 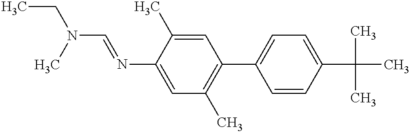 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-17 | 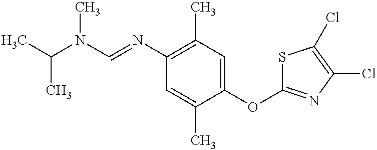 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-18 | 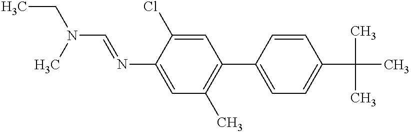 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-19 | 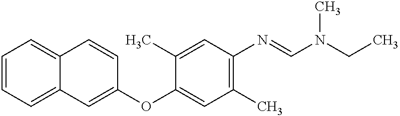 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-21 | 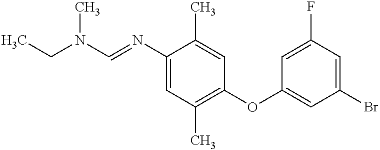 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-22 | 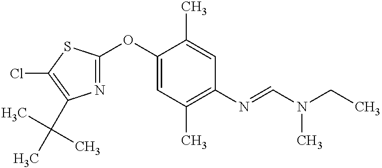 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-23 | 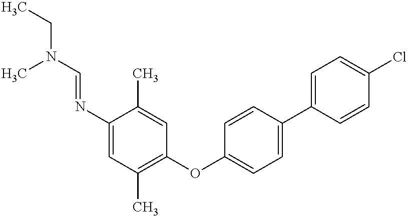 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-25 | 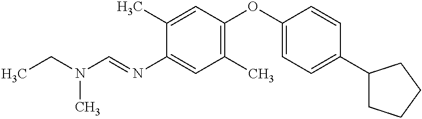 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-26 | 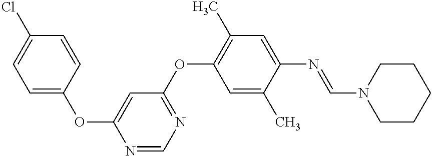 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-27 | 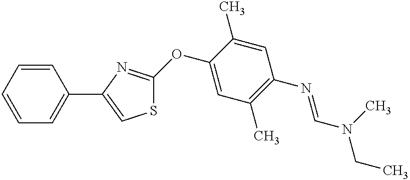 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-28 | 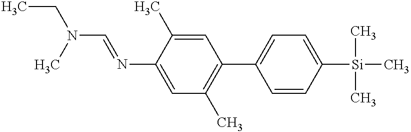 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-29 | 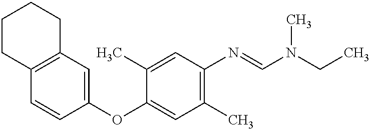 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-30 | 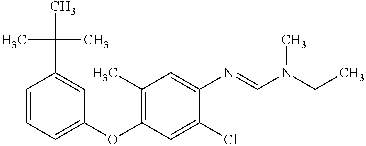 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-31 | 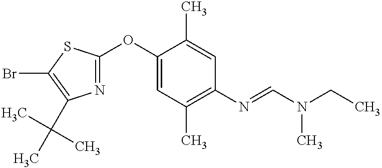 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-32 | 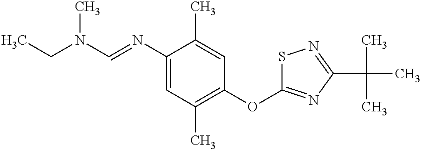 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-33 | 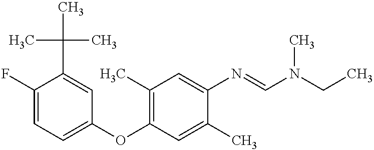 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-34 | 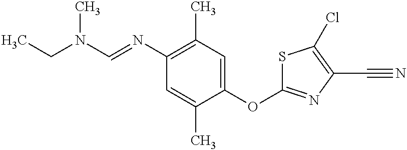 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-35 | 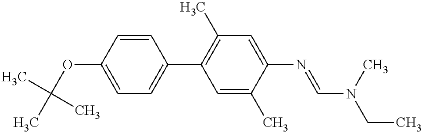 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-36 | 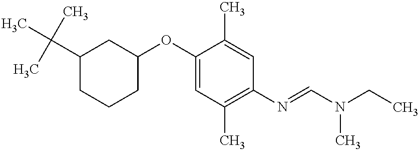 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-37 | 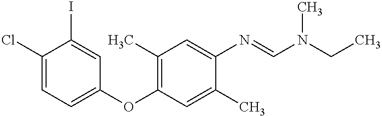 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-38 | 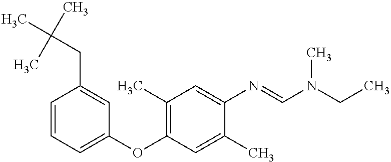 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-39 | 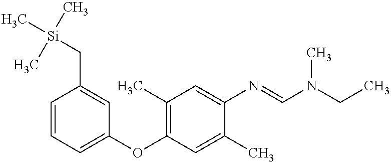 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-40 | 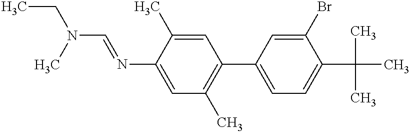 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-41 | 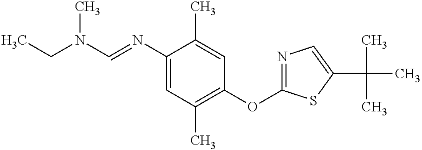 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-42 | 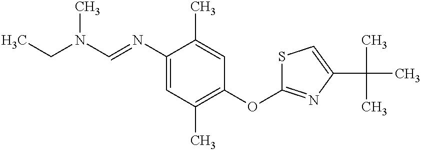 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-43 | 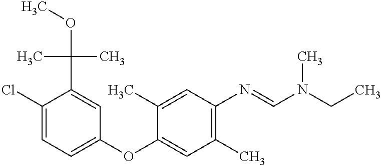 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-44 | 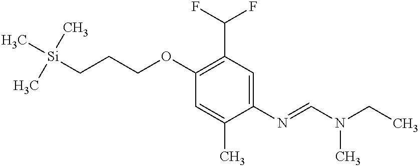 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-45 | 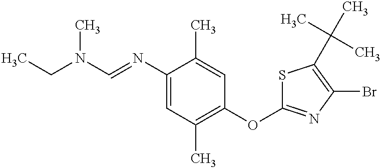 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-46 | 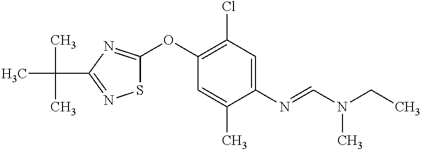 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-47 | 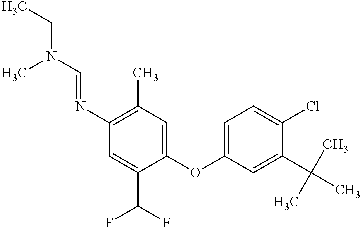 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-48 | 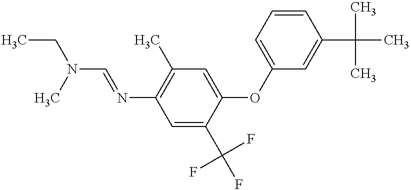 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-49 | 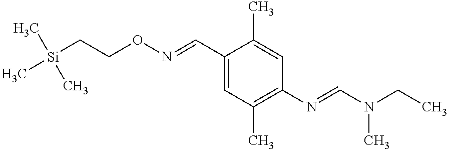 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-50 | 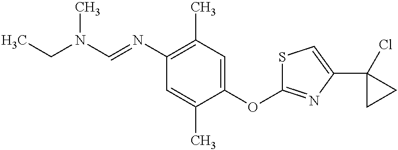 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-51 | 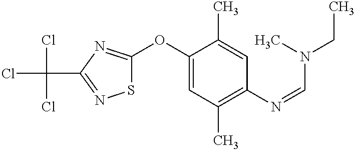 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-52 | 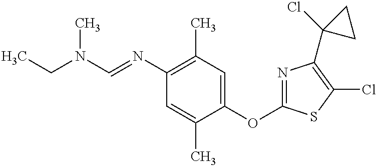 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-53 | 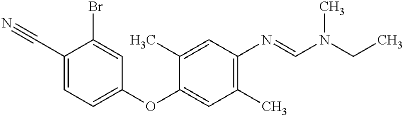 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-54 | 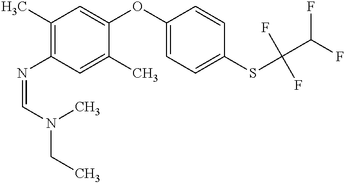 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-55 | 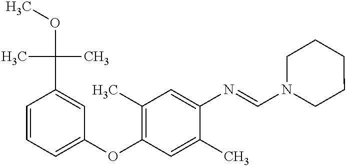 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-56 | 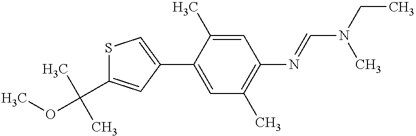 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-57 | 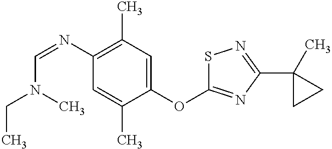 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-58 | 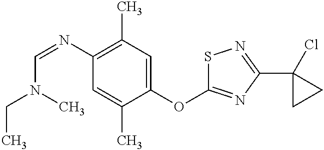 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-59 | 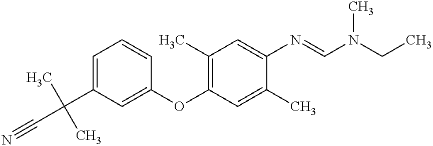 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-60 | 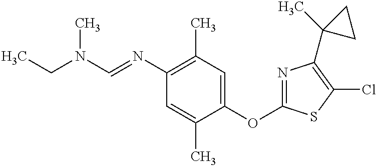 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-61 | 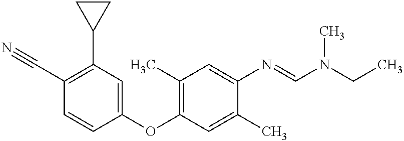 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-62 | 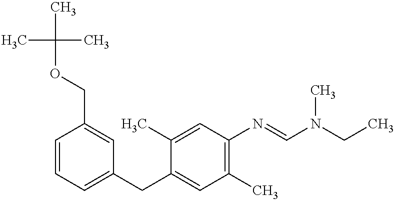 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-63 | 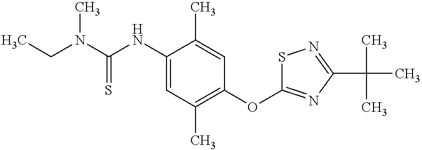 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-64 | 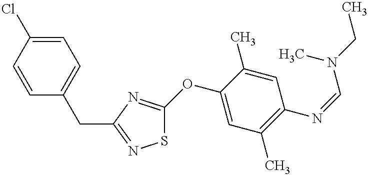 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-65 | 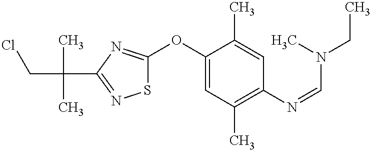 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-66 | 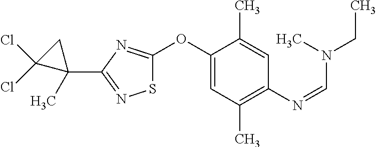 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-67 | 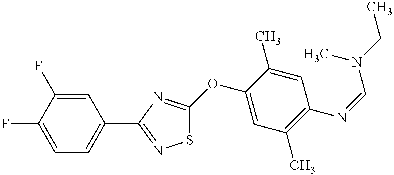 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-68 | 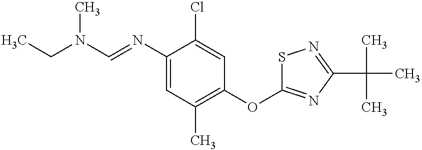 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-69 | 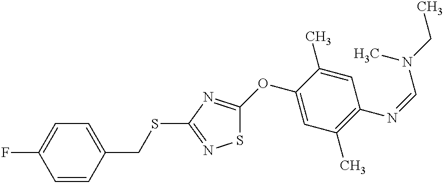 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-70 | 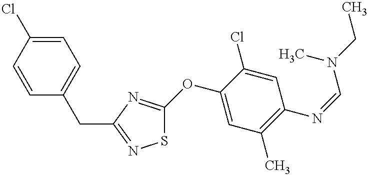 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-71 | 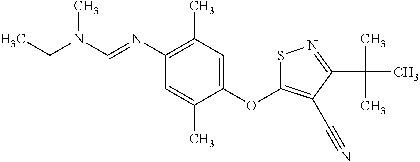 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-72 | 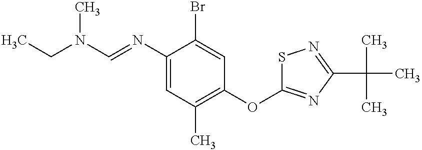 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-73 | 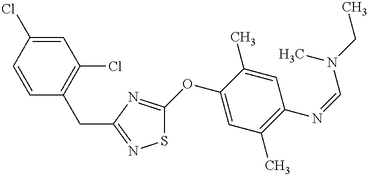 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-74 | 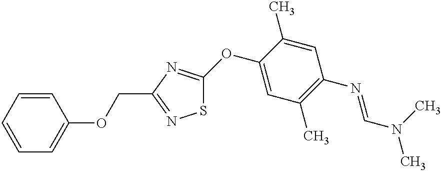 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-75 | 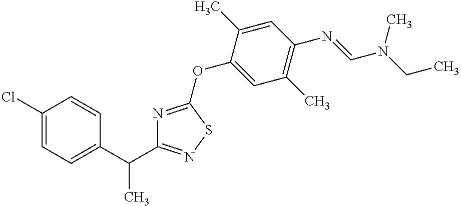 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-76 | 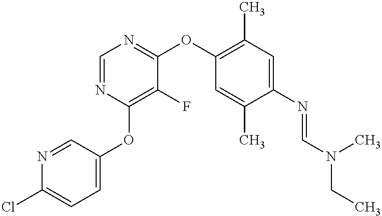 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-77 | 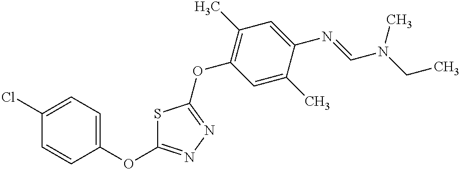 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-78 | 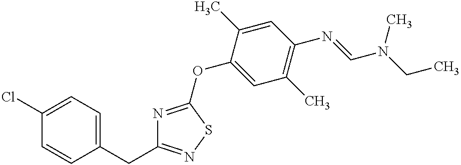 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |
| A-79 | 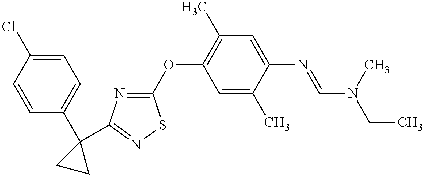 | B-1, B-2, B-3, B-4, B-5, B-6, B-7, B-8, B-9, B-10, B-11, B-12, B-13, B-14, B-15, B-16, B-17, B-18, B-19, B-20, B-21, B-22, B-23, B-24, B-25, B-26, B-27, B-28, B-29, B-30, B-31, B-32, B-33, B-34, B-35, B-36, B-37, B-38 |

N-cycloalkylamide compounds (B) of formula (II) which can be used as combination partners according to column 3 of table A are listed in table B below.

TABLE B

| N-cyclo- | |
|---|---|
| alkylamide | |
| No. | Structure |
| B-1 | 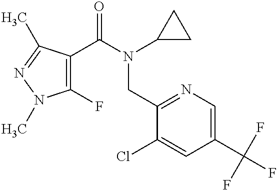 |
| B-2 | 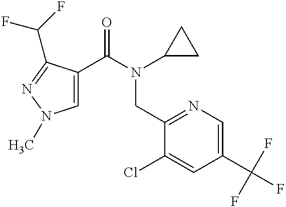 |
| B-3 | 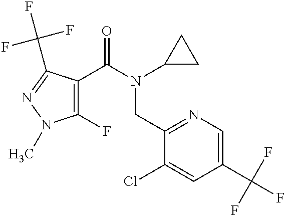 |
| B-4 | 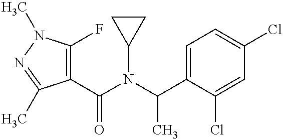 |
| B-5 | 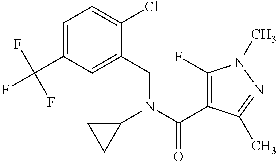 |
| B-6 | 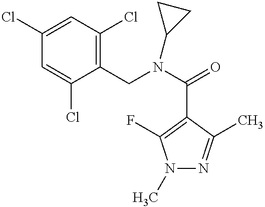 |
| B-7 | 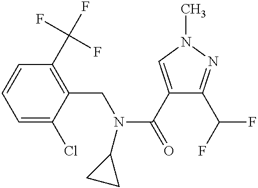 |
| B-8 | 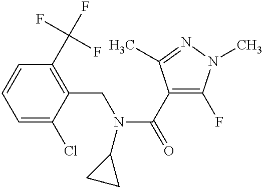 |
| B-9 | 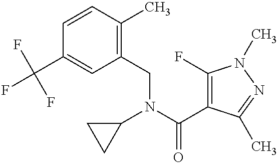 |
| B-10 | 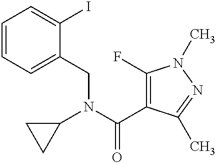 |
| B-11 | 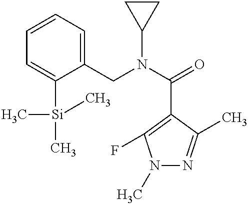 |
| B-12 | 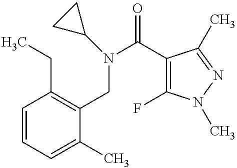 |
| B-13 | 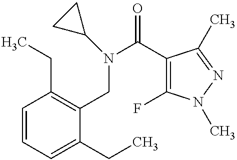 |
| B-14 | 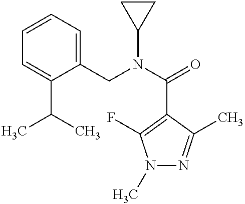 |
| B-15 | 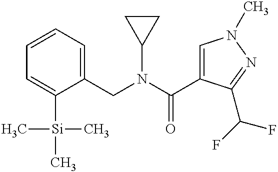 |
| B-16 | 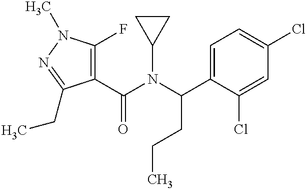 |
| B-17 | 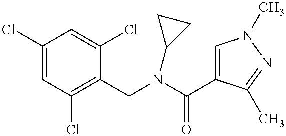 |
| B-18 | 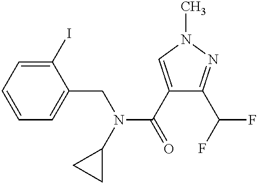 |
| B-19 | 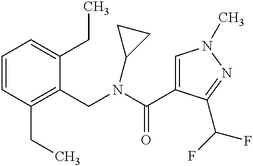 |
| B-20 | 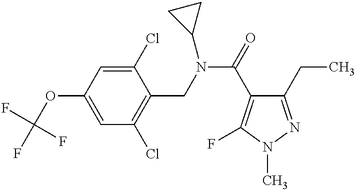 |
| B-21 | 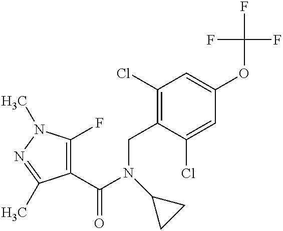 |
| B-22 | 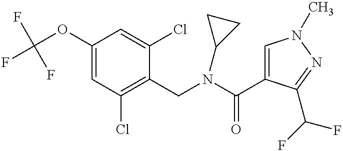 |
| B-23 | 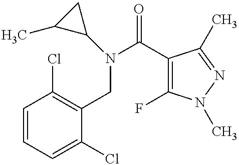 |
| B-24 | 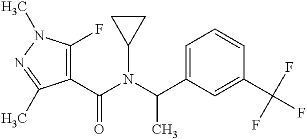 |
| B-25 | 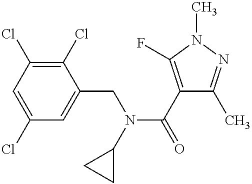 |
| B-26 | 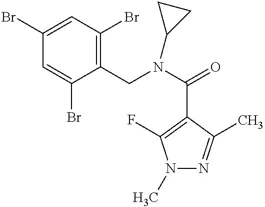 |
| B-27 | 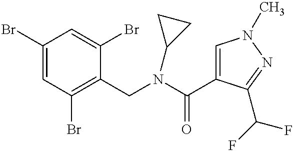 |
| B-28 | 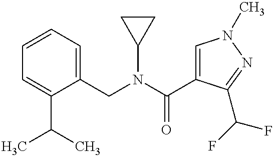 |
| B-29 | 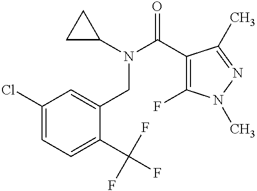 |
| B-30 | 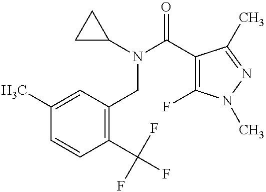 |
| B-31 | 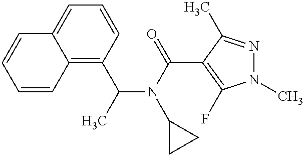 |
| B-32 | 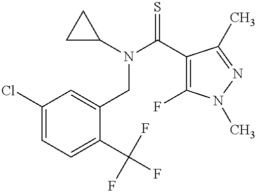 |
| B-33 | 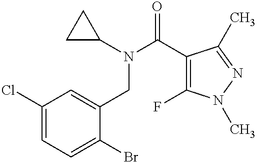 |
| B-34 | 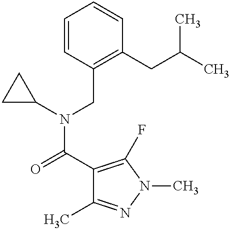 |
| B-35 | 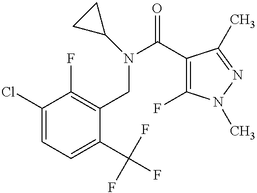 |
| B-36 | 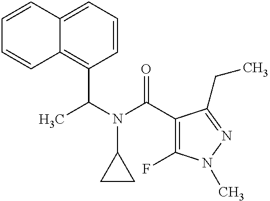 |
| B-37 | 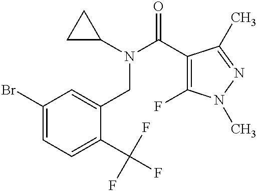 |
| B-38 | 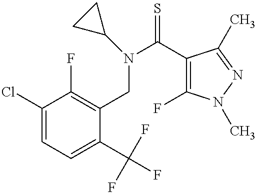 |

In the combinations according to the invention the compounds (A) and (B) are present in a synergistically effective weight ratio of A:B in a range of 100:1 to 1:100, preferably in a weight ratio of 50:1 to 1:50, most preferably in a weight ratio of 20:1 to 1:20. Further ratios of A:B which can be used according to the present invention with increasing preference in the order given are: 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 45:1 to 1:45, 40:1 to 1:40, 35:1 to 1:35, 30:1 to 1:30, 25:1 to 1:25, 15:1 to 1:15, 10:1 to 1:10, 5:1 to 1:5, 4:1 to 1:4, 3:1 to 1:3, 2:1 to 1:2.

Where a compound (A) or a compound (B) can be present in tautomeric form, such a compound is understood hereinabove and hereinbelow also to include, where applicable, corresponding tautomeric forms, even when these are not specifically mentioned in each case.

Compounds (A) or compounds (B) having at least one basic centre are capable of forming, for example, acid addition salts, e.g. with strong inorganic acids, such as mineral acids, e.g. perchloric acid, sulfuric acid, nitric acid, nitrous acid, a phosphoric acid or a hydrohalic acid, with strong organic carboxylic acids, such as unsubstituted substituted, e.g. halo-substituted, C₁-C₄ alkanecarboxylic acids, e.g. acetic acid, saturated or unsaturated dicarboxylic acids, e.g. oxalic, malonic, succinic, maleic, fumaric and phthalic acid, hydroxycarboxylic acids, e.g. ascorbic, lactic, malic, tartaric and citric acid, or benzoic acid, or with organic sulfonic acids, such as unsubstituted or substituted, e.g. halo-substituted, C₁-C₄alkane- or aryl-sulfonic acids, e.g. methane- or p-toluene-sulfonic acid. Compounds (A) or compounds (B) having at least one acid group are capable of forming, for example, salts with bases, e.g. metal salts, such as alkali metal or alkaline earth metal salts, e.g. sodium, potassium or magnesium salts, or salts with ammonia or an organic amine, such as morpholine, piperidine, pyrrolidine, a mono-, di- or tri-lower alkylamine, e.g. ethyl-, diethyl-, triethyl- or dimethyl-propyl-amine, or a mono-, di- or tri-hydroxy-lower alkylamine, e.g. mono-, di- or tri-ethanolamine. In addition, corresponding internal salts may optionally be formed. In the context of the invention, preference is given to agrochemically advantageous salts. In view of the close relationship between the compounds (A) or the compounds (B) in free form and in the form of their salts, hereinabove and herein below any reference to the free compounds (A) or free compounds (B) or to their salts should be understood as including also the corresponding salts or the free compounds (A) or free compounds (B), respectively, where appropriate and expedient. The equivalent also applies to tautomers of compounds (A) or compounds (B) and to their salts.

According to the invention the expression “combination” stands for the various combinations of compounds (A) and (B), for example in a single “ready-mix” form, in a combined spray mixture composed from separate formulations of the single active compounds, such as a “tank-mix”, and in a combined use of the single active ingredients when applied in a sequential manner, i.e. one after the other with a reasonably short period, such as a few hours or days. Preferably the order of applying the compounds (A) and (B) is not essential for working the present invention. The compounds (B) are listed by common names followed by the corresponding CAS-numbers in parenthesis. If no common name was available at the priority date of the application compounds (B) are listed by IUPAC-names followed by the corresponding CAS-numbers in parenthesis.

In a further aspect there is provided a composition comprising a combination according to this invention. Preferably the fungicidal composition comprises an agriculturally acceptable support, carrier or filler. According to the invention, the term “support” denotes a natural or synthetic, organic or inorganic compound with which the active compound of formula (I) is combined or associated to make it easier to apply, notably to the parts of the plant. This support is thus generally inert and should be agriculturally acceptable. The support may be a solid or a liquid. Examples of suitable supports include clays, natural or synthetic silicates, silica, resins, waxes, solid fertilisers, water, alcohols, in particular butanol, organic solvents, mineral and plant oils and derivatives thereof. Mixtures of such supports may also be used.

The composition according to the invention may also comprise additional components. In particular, the composition may further comprise a surfactant. The surfactant can be an emulsifier, a dispersing agent or a wetting agent of ionic or non-ionic type or a mixture of such surfactants. Mention may be made, for example, of polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (in particular alkylphenols or arylphenols), salts of sulphosuccinic acid esters, taurine derivatives (in particular alkyl taurates), phosphoric esters of polyoxyethylated alcohols or phenols, fatty acid esters of polyols, and derivatives of the present compounds containing sulphate, sulphonate and phosphate functions. The presence of at least one surfactant is generally essential when the active compound and/or the inert support are water-insoluble and when the vector agent for the application is water. Preferably, surfactant content may be comprised from 5% to 40% by weight of the composition.

Colouring agents such as inorganic pigments, for example iron oxide, titanium oxide, ferrocyanblue, and organic pigments such as alizarin, azo and metallophthalocyanine dyes, and trace elements such as iron, manganese, boron, copper, cobalt, molybdenum and zinc salts can be used.

Optionally, other additional components may also be included, e.g. protective colloids, adhesives, thickeners, thixotropic agents, penetration agents, stabilisers, sequestering agents. More generally, the active compounds can be combined with any solid or liquid additive, which complies with the usual formulation techniques.

In general, the composition according to the invention may contain from 0.05 to 99% by weight of active compounds, preferably from 10 to 70% by weight.

The combination or composition according to the invention can be used as such, in form of their formulations or as the use forms prepared therefrom, such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ULV) liquid, ultra low volume (ULV) suspension, water dispersible granules or tablets, water dispersible powder for slurry treatment, water soluble granules or tablets, water soluble powder for seed treatment and wettable powder.

The treatment of plants and plant parts with the active compound combination according to the invention is carried out directly or by action on their environment, habitat or storage area by means of the normal treatment methods, for example by watering (drenching), drip irrigation, spraying, atomizing, broadcasting, dusting, foaming, spreading-on, and as a powder for dry seed treatment, a solution for seed treatment, a water-soluble powder for seed treatment, a water-soluble powder for slurry treatment, or by encrusting.

These compositions include not only compositions which are ready to be applied to the plant or seed to be treated by means of a suitable device, such as a spraying or dusting device, but also concentrated commercial compositions which must be diluted before application to the crop.

The active compounds within the composition according to the invention have potent microbicide activity and can be employed for controlling undesired micro-organisms, such as fungi or bacteria, in crop protection or in the protection of materials.

Within the composition according to the invention, fungicide compounds can be employed in crop protection for example for controlling Plasmodiophoromycetes, Oomycetes, Chytridiomycetes, Zygomycetes, Ascomycetes, Basidiomycetes and Deuteromycetes.

Within the composition according to the invention, bactericide compounds can be employed in crop protection for example for controlling Pseudomonadaceae, Rhizobiaceae, Enterobacteriaceae, Corynebacteriaceae and Streptomycetaceae.

The fungicide composition according to the invention can be used to curatively or preventively control the phytopathogenic fungi of plants or crops. Thus, according to a further aspect of the invention, there is provided a method for curatively or preventively controlling the phytopathogenic fungi of plants or crops comprising the use of a fungicide composition according to the invention by application to the seed, the plant or to the fruit of the plant or to the soil in which the plant is growing or in which it is desired to grow.

The composition of the invention is also suitable for the treatment of seeds. (A) large part of the damage caused by pests on cultigens occurs by infestation of the seed during storage and after sowing the seed in the ground as well as during and after germination of the plants. This phase is especially critical since the roots and shoots of the growing plant are particularly sensitive and even a small amount of damage can lead to withering of the whole plant.

The method of treatment according to the invention may also be useful to treat propagation material such as tubers or rhizomes, but also seeds, seedlings or seedlings pricking out and plants or plants pricking out. This method of treatment can also be useful to treat roots. The method of treatment according to the invention can also be useful to treat the over-ground parts of the plant such as trunks, stems or stalks, leaves, flowers and fruit of the concerned plant.

Among the plants that can be protected by the method according to the invention, mention may be made of cotton; flax; vine; fruit or vegetable crops such as Rosaceae sp. (for instance pip fruit such as apples and pears, but also stone fruit such as apricots, almonds and peaches), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for instance banana trees and plantins), Rubiaceae sp., Theaceae sp., Sterculiceae sp., Rutaceae sp. (for instance lemons, oranges and grapefruit); Solanaceae sp. (for instance tomatoes), Liliaceae sp., Asteraceae sp. (for instance lettuces), Umbelliferae sp., Cruciferae sp., Chenopodiaceae sp., Cucurbitaceae sp., Papilionaceae sp. (for instance peas), Rosaceae sp. (for instance strawberries); major crops such as Graminae sp. (for instance maize, lawn or cereals such as wheat, rye, rice, barley and triticale), Asteraceae sp. (for instance sunflower), Cruciferae sp. (for instance colza), Fabacae sp. (for instance peanuts), Papilionaceae sp. (for instance soybean), Solanaceae sp. (for instance potatoes), Chenopodiaceae sp. (for instance beetroots); horticultural and forest crops; as well as genetically modified homologues of these crops.

The method of treatment according to the invention can be used in the treatment of genetically modified organisms, e.g. plants or seeds. Genetically modified plants are plants of which a heterologous gene encoding a protein of interest has been stably integrated into genome. The expression “heterologous gene encoding a protein of interest” essentially means genes which give the transformed plant new agronomic properties, or genes for improving the agronomic quality of the modified plant.

A further aspect of the instant invention is a method of protecting natural substances of vegetable or animal origin or their processed forms, which have been taken from the natural life cycle, which comprises applying to said natural substances of vegetable or animal origin or their processed forms a combination of compounds (A) and (B) in a synergistically effective amount.

A preferred embodiment is a method of protecting natural substances of vegetable origin or their processed forms, which have been taken from the natural life cycle, which comprises applying to said natural substances of vegetable origin or their processed forms a combination of compounds (A) and (B) in a synergistically effective amount.

A further preferred embodiment is a method of protecting fruit, preferably pomes, stone fruits, soft fruits and citrus fruits, or their processed forms, which have been taken from the natural life cycle, which comprises applying to said natural substances of vegetable origin or their processed forms a combination of compounds (A) and (B) in a synergistically effective amount.

The combinations of the present invention may also be used in the field of protecting technical material against attack of fungi. According to the instant invention, the term “technical material” includes paper; carpets; constructions; cooling and heating systems; wall-boards; ventilation and air conditioning systems and the like. The combinations according the present invention can prevent disadvantageous effects such as decay, discoloration or mold. Preferably “storage goods” is understood to denote wall-boards.

The method of treatment according to the invention can also be used in the field of protecting storage goods against attack of fungi. According to the instant invention, the term “storage goods” is understood to denote natural substances of vegetable or animal origin and their processed forms, which have been taken from the natural life cycle and for which long-term protection is desired. Storage goods of vegetable origin, such as plants or parts thereof, for example stalks, leafs, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The combinations according the present invention can prevent disadvantageous effects such as decay, discoloration or mold. Preferably “storage goods” is understood to denote natural substances of vegetable origin and their processed forms, more preferably fruits and their processed forms, such as pomes, stone fruits, soft fruits and citrus fruits and their processed forms.

In another preferred embodiment of the invention “storage goods” is understood to denote wood. The fungicide combination or composition according to the invention may also be used against fungal diseases liable to grow on or inside timber. The term “timber” means all types of species of wood, and all types of working of this wood intended for construction, for example solid wood, high-density wood, laminated wood, and plywood. The method for treating timber according to the invention mainly consists in contacting one or more compounds according to the invention, or a composition according to the invention; this includes for example direct application, spraying, dipping, injection or any other suitable means.

Among the diseases of plants or crops that can be controlled by the method according to the invention, mention may be made of:
Powdery Mildew Diseases such as
Blumeria diseases caused for example by Blumeria graminis
Podosphaera diseases caused for example by Podosphaera leucotricha
Sphaerotheca diseases caused for example by Sphaerotheca fuliginea
Uncinula diseases caused for example by Uncinula necator
Rust Diseases such as
Gymnosporangium diseases caused for example by Gymnosporangium sabinae
Hemileia diseases caused for example by Hemileia vastatrix
Phakopsora diseases caused for example by Phakopsora pachyrhizi and Phakopsora meibomiae
Puccinia diseases caused for example by Puccinia recondite, and Puccinia triticina;
Uromyces diseases caused for example by Uromyces appendiculatus
Oomycete Diseases such as
Bremia diseases caused for example by Bremia lactucae
Peronospora diseases caused for example by Peronospora pisi and Peronospora brassicae
Phytophthora diseases caused for example by Phytophthora infestans
Plasmopara diseases caused for example by Plasmopara viticola
Pseudoperonospora diseases caused for example by Pseudoperonospora humuli and Pseudoperonospora cubensis

Pythium diseases caused for example by Pythium ultimum
Leafspot, Leaf blotch and Leaf Blight Diseases such as
Alternaria diseases caused for example by Alternaria solani
Cercospora diseases caused for example by Cercospora beticola
Cladiosporium diseases caused for example by Cladiosporium cucumerinum
Cochliobolus diseases caused for example by Cochliobolus sativus
(Conidiaform: Drechslera, Syn: Helminthosporium);
Colletotrichum diseases caused for example by Colletotrichum lindemuthianum
Cycloconium diseases caused for example by Cycloconium oleaginum
Diaporthe diseases caused for example by Diaporthe citri
Elsinoe diseases caused for example by Elsinoe fawcettii
Gloeosporium diseases caused for example by Gloeosporium laeticolor
Glomerella diseases caused for example by Glomerella cingulata
Guignardia diseases caused for example by Guignardia bidwellii
Leptosphaeria diseases caused for example by Leptosphaeria maculans
Magnaporthe diseases caused for example by Magnaporthe grisea
Mycosphaerella diseases caused for example by Mycosphaerella graminicola and Mycosphaerella fijiensis
Phaeosphaeria diseases caused for example by Phaeosphaeria nodorum
Pyrenophora diseases caused for example by Pyrenophora teres
Ramularia diseases caused for example by Ramularia collo-cygni
Rhynchosporium diseases caused for example by Rhynchosporium secalis
Septoria diseases caused for example by Septoria apii;
Typhula diseases caused for example by Thyphula incarnata
Venturia diseases caused for example by Venturia inaequalis
Root- and Stem Diseases such as
Corticium diseases caused for example by Corticium graminearum
Fusarium diseases caused for example by Fusarium oxysporum
Gaeumannomyces diseases caused for example by Gaeumannomyces graminis
Rhizoctonia diseases caused for example by Rhizoctonia solani
Oculimacula (Tapesia) diseases caused for example by Oculimacula Tapesia acuformis
Thielaviopsis diseases caused for example by Thielaviopsis basicola
Ear and Panicle Diseases including Maize cob such as
Alternaria diseases caused for example by Alternaria spp.
Aspergillus diseases caused for example by Aspergillus flavus
Cladosporium diseases caused for example by Cladiosporium cladosporioides
Claviceps diseases caused for example by Claviceps purpurea
Fusarium diseases caused for example by Fusarium culmorum
Gibberella diseases caused for example by Gibberella zeae
Monographella diseases caused for example by Monographella nivalis
Smut- and Bunt Diseases such as
Sphacelotheca diseases caused for example by Sphacelotheca reiliana
Tilletia diseases caused for example by Tilletia caries
Urocystis diseases Urocystis occulta
Ustilago diseases caused for example by Ustilago nuda;
Fruit Rot and Mould Diseases such as
Aspergillus diseases caused for example by Aspergillus flavus
Botrytis diseases caused for example by Botrytis cinerea
Penicillium diseases caused for example by Penicillium expansum and Penicillium purpurogenum
Sclerotinia diseases caused for example by Sclerotinia sclerotiorum;
Verticillium diseases caused for example by Verticillium alboatrum
Seed- and Soilborne Decay, Mould, Wilt, Rot and Damping-off diseases
Fusarium diseases caused for example by Fusarium culmorum
Phytophthora diseases caused for example by Phytophthora cactorum
Pythium diseases caused for example by Pythium ultimum
Rhizoctonia diseases caused for example by Rhizoctonia solani
Sclerotium diseases caused for example by Sclerotium rolfsii
Canker, Broom and Dieback Diseases such as
Nectria diseases caused for example by Nectria galligena
Blight Diseases such as
Monilinia diseases caused for example by Monilinia laxa
Leaf Blister or Leaf Curl Diseases including deformation of blooms and fruits such as
Taphrina diseases caused for example by Taphrina deformans
Decline Diseases of Wooden Plants such as
Esca disease caused for example by Phaeomoniella clamydospora and Phaeoacremonium aleophilum and Fomitiporia mediterranea
Diseases of Flowers and Seeds such as
Botrytis diseases caused for example by Botrytis cinerea
Diseases of Tubers such as
Rhizoctonia diseases caused for example by Rhizoctonia solani
Helminthosporium diseases caused for example by Helminthosporium solani
Diseases caused by Bacterial Organisms such as
Xanthomanas species for example Xanthomonas campestris pv. Oryzae
Pseudomonas species for example Pseudomonas syringae pv. Lachrymans
Erwinia species for example Erwinia amylovora.

The compounds related to this invention are preferably used to control the following soybean diseases:

Fungal Diseases of the Foliage, Upper Stems, Pods and Seeds for example

Alternaria leaf spot (Alternaria spec. atrans tenuissima), Anthracnose (Colletotrichum gloeosporoides dematium var. truncatum), Brown spot (Septoria glycines), Cercospora leaf spot and blight (Cercospora kikuchii), Choanephora leaf blight (Choanephora infundibulifera trispora (Syn.)), Dactuliophora leaf spot (Dactuliophora glycines), Downy Mildew (Peronospora manshurica), Drechslera blight (Drechslera glycini), Frogeye Leaf spot (Cercospora sojina), Leptosphaerulina Leaf Spot (Leptosphaerulina trifolii), Phyllostica Leaf Spot (Phyllosticta sojaecola), Pod and Stem Blight (Phomopsis sojae), Powdery Mildew (Microsphaera diffusa), Pyrenochaeta Leaf Spot (Pyrenochaeta glycines), Rhizoctonia Aerial, Foliage, and Web Blight (Rhizoctonia solani), Rust (Phakopsora pachyrhizi, Phakopsora meibomiae), Scab (Sphaceloma glycines), Stemphylium Leaf Blight (Stemphylium botryosum), Target Spot (Corynespora cassiicola)
Fungal Disease of the Roots and Lower Stems for example
Black Root Rot (Calonectria crotalariae), Charcoal Rot (Macrophomina phaseolina), Fusarium Blight or Wilt, Root Rot, and Pod and Collar Rot (Fusarium oxysporum, Fusarium orthoceras, Fusarium semitectum, Fusarium equiseti), Mycoleptodiscus Root Rot (Mycoleptodiscus terrestris), Neocosmospora (Neocosmopspora vasinfecta), Pod and Stem Blight (Diaporthe phaseolorum), Stem Canker (Diaporthe phaseolorum var. caulivora), Phytophthora Rot (Phytophthora megasperma), Brown Stem Rot (Phialophora gregata), Pythium Rot (Pythium aphanidermatum, Pythium irregulare, Pythium debaryanum, Pythium myriotylum, Pythium ultimum), Rhizoctonia Root Rot, Stem Decay, and Damping-Off (Rhizoctonia solani), Sclerotinia Stem Decay (Sclerotinia sclerotiorum), Sclerotinia Southern Blight (Sclerotinia rolfsii), Thielaviopsis Root Rot (Thielaviopsis basicola).

The method of treatment according to the invention also provides the use of compounds (A) and (B) in a simultaneous, separate or sequential manner

The dose of active compound usually applied in the method of treatment according to the invention is generally and advantageously
for foliar treatments: from 0.1 to 10,000 g/ha, preferably from 10 to 1,000 g/ha, more preferably from 50 to 300g/ha; in case of drench or drip application, the dose can even be reduced, especially while using inert substrates like rockwool or perlite;
for seed treatment: from 2 to 200 g per 100 kilogram of seed, preferably from 3 to 150 g per 100 kilogram of seed;
for soil treatment: from 0.1 to 10,000 g/ha, preferably from 1 to 5,000 g/ha.

The doses herein indicated are given as illustrative examples of the method according to the invention. A person skilled in the art will know how to adapt the application doses, notably according to the nature of the plant or crop to be treated.

The compounds or mixtures according to the invention may also be used for the preparation of composition useful to curatively or preventively treat human or animal fungal diseases such as, for example, mycoses, dermatoses, trichophyton diseases and candidiases or diseases caused by Aspergillus spp., for example Aspergillus fumigatus.

### Mycotoxins

Furthermore compounds or mixtures according to the invention may also be used to reduce the contents of mycotoxins in the harvested crops and therefore in foods and animal feed stuff made therefrom.

Especially but not exclusively the following mycotoxins can be specified:

Deoxynivalenole (DON), Nivalenole, 15-Ac-DON, 3-Ac-DON, T2- und HT2- Toxins, Fumonisines, Zearalenone Moniliformine, Fusarine, Diaceotoxyscirpenole (DAS), Beauvericine, Enniatine, Fusaroproliferine, Fusarenole, Ochratoxins, Patuline, Ergotalcaloides und Aflatoxins, which are caused for example by the following fungal diseases: Fusarium spec., like Fusarium acuminatum, F. avenaceum, F. crookwellense, F. culmorum, F. graminearum (Gibberella zeae), F. equiseti, F. fujikoroi, F. musarum, F. oxysporum, F. proliferatum, F. poae, F. pseudograminearum, F. sambucinum, F. scirpi, F. semitectum, F. solani, F. sporotrichoides, F. langsethiae, F. subglutinans, F. tricinctum, F. verticillioides and others but also by Aspergillus spec., Penicillium spec., Claviceps purpurea, Stachybotrys spec. and others.

### Treatment of Seeds

The invention comprises a procedure in which the seed is treated at the same time with a compound of Group (A) and a compound selected from group (B). It further comprises a method in which the seed is treated with compound of Group (A) and a compound selected from group (B) separately.

The invention also comprises a seed, which has been treated with a compound of Group (A) and a compound selected from group (B) at the same time. The invention also comprises a seed, which has been treated with a compound of Group (A) and a compound selected from group (B) separately. For the latter seed, the active ingredients can be applied in separate layers. These layers can optionally be separated by an additional layer that may or may not contain an active ingredient.

The mixtures of the invention are particularly suitable for the treatment of seeds. A large part of the damage caused by pests on cultigens occurs by infestation of the seed during storage and after sowing the seed in the ground as well as during and after germination of the plants. This phase is especially critical since the roots and shoots of the growing plant are particularly sensitive and even a small amount of damage can lead to withering of the whole plant. There is therefore considerable interest in protecting the seed and the germinating plant by the use of suitable agents.

The control of pests by treatment of the seeds of plants has been known for a considerable time and is the object of continuous improvement. However, there are a number of problems in the treatment of seed that cannot always be satisfactorily solved. Therefore it is worthwhile to develop methods for the protection of seeds and germinating plants which makes the additional application of plant protection agents after seeding or after germination of the plants superfluous. It is further worthwhile to optimize the amount of the applied active material such that the seed and the germinating plants are protected against infestation by pests as best as possible without the plants themselves being damaged by the active compound applied. In particular, methods for the treatment seed should also take into account the intrinsic insecticidal properties of transgenic plants in order to achieve optimal protection of the seed and germinating plants with a minimal expenditure of plant protection agents.

The present invention relates therefore especially to a method for the protection of seed and germinating plants from infestation with pests in that the seed is treated with the combination/composition of the invention. In addition the invention relates also to the use of the combination/composition of the invention for the treatment seed for protection of the seed and the germinating plants from pests. Furthermore the invention relates to seed which was treated with an combination/composition of the invention for protection from pests.

One of the advantages of the invention is because of the special systemic properties of the combination/composition of the invention treatment with these combination/composition protects not only the seed itself from pests but also the plants emerging after sprouting. In this way the direct treatment of the culture at the time of sowing or shortly thereafter can be omitted.

A further advantage is the synergistic increase in insecticidal activity of the combination/composition of the invention in comparison to the respective individual active compounds, which extends beyond the sum of the activity of both individually applied active compounds. In this way an optimization of the amount of active compound applied is made possible.

It is also be regarded as advantageous that the mixtures of the invention can also be used in particular with transgenic seeds whereby the plants emerging from this seed are capable of the expression of a protein directed against pests. By treatment of such seed with the agents of the invention certain pests can already be controlled by expression of the, for example, insecticidal protein, and it is additionally surprising that a synergistic activity supplementation occurs with the agents of the invention, which improves still further the effectiveness of the protection from pest infestation.

The agents of the invention are suitable for the protection of seed of plant varieties of all types as already described which are used in agriculture, in greenhouses, in forestry, in garden construction or in vineyards. In particular, this concerns seed of maize, peanut, canola, rape, poppy, olive, coconut, cacao, soy, cotton, beet, (e.g. sugar beet and feed beet), rice, millet, wheat, barley, oats, rye, sunflower, sugar cane or tobacco. The combination/compositions of the invention are also suitable for the treatment of the seed of fruit plants and vegetables as previously described. Particular importance is attached to the treatment of the seed of maize, soy, cotton, wheat and canola or rape.

As already described, the treatment of transgenic seed with a combination/composition of the invention is of particular importance. This concerns the seeds of plants which generally contain at least one heterologous gene that controls the expression of a polypeptide with special insecticidal properties. The heterologous gene in transgenic seed can originate from microorganisms such as Bacillus, Rhizobium, Pseudomonas, Serratia, Trichoderma, Clavibacter, Glomus or Gliocladium. The present invention is particularly suitable for the treatment of transgenic seed that contains at least one heterologous gene that originates from Bacillus sp. and whose gene product exhibits activity against the European corn borer and/or western corn rootworm. Particularly preferred is a heterologous gene that originates from Bacillus thuringiensis.

Within the context of the present invention the combination/ composition of the invention is applied to the seed alone or in a suitable formulation. Preferably the seed is handled in a state in which it is so stable, that no damage occurs during treatment. In general treatment of the seed can be carried out at any time between harvest and sowing. Normally seed is used that was separated from the plant and has been freed of spadix, husks, stalks, pods, wool or fruit flesh. Use of seed that was harvested, purified, and dried to moisture content of below 15% w/w. Alternatively, seed treated with water after drying and then dried again can also be used.

In general care must be taken during the treatment of the seed that the amount of the combination/composition of the invention and/or further additive applied to the seed is so chosen that the germination of the seed is not impaired and the emerging plant is not damaged. This is to be noted above all with active compounds which can show phytotoxic effects when applied in certain amounts.

The combination/compositions of the invention can be applied directly, that is without containing additional components and without being diluted. It is normally preferred to apply the combination/ composition to the seed in the form of a suitable formulation. Suitable formulations and methods for seed treatment are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1,WO 2002/080675 A1, WO 2002/028186 A2.

According to another aspect of the present invention, in the combination or composition according to the invention, the compound ratio A/B may be advantageously chosen so as to produce a synergistic effect. The term synergistic effect is understood to mean in particular that defined by Colby in an article entitled “Calculation of the synergistic and antagonistic responses of herbicide combinations” Weeds, (1967), 15, pages 20-22.

The latter article mentions the formula:

$$E = X + Y - \frac{X Y}{100}$$

wherein E represents the expected percentage of inhibition of the pest for the combination of the two compounds at defined doses (for example equal to x and y respectively), X is the percentage of inhibition observed for the pest by compound (A) at a defined dose (equal to x), Y is the percentage of inhibition observed for the pest by compound (B) at a defined dose (equal to y). When the percentage of inhibition observed for the combination is greater than E, there is a synergistic effect.

The term “synergistic effect” also means the effect defined by application of the Tammes method, “Isoboles, a graphic representation of synergism in pesticides”, Netherlands Journal of Plant Pathology, 70(1964), pages 73-80.

1. A compound combination comprising
(A) an arylamidine derivative of formula (I): 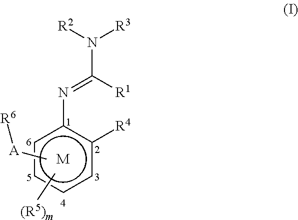
wherein:
R¹ is an alkyl, an alkenyl, an alkynyl, a carbocyclic or heterocyclic monovalent group, it being possible for each of these groups to be substituted, or hydrogen
R², R³ which may be identical or different, are any one of the groups defined for R¹; a cyano; an acyl; —OR^{a} or —SR^{a}, with R^{a} corresponding to an alkyl, an alkenyl, an alkynyl, a carbocyclic or heterocyclic monovalent group, it being possible for each of these groups to be substituted, or R² and R³, or R² and R¹ may form together and with the atoms linking them, a ring which may be substituted;
R⁴ is an alkyl, an alkenyl, an alkynyl, a carbocyclic or heterocyclic monovalent group, it being possible for each of these groups to be substituted, a hydroxyl group; mercapto;
azido; nitro; halo; cyano; optionally substituted acyl, amino; cyanato; thiocyanato; —SF₅; —OR^{a}; —SR^{a} or —Si(Ra)₃;
m is an integer from 0 to 3;
R⁵ which may be mutually identical or different, have the same definition as that given above for R⁴;
R⁶ is optionally substituted with a carbocyclic or hetrocyclic monovalent group; and
A is a direct bond, —O—, —S(O)ₙ—, —NR⁹—, —CR⁷═CR⁷—, —C≡C—, -A¹-, -A¹-A¹, —O-(A¹k-O—, —O-(A¹)ₖ-, -A³-, -A⁴-, -A¹S(O)ₙ—, -A²-, OA²-, —NR⁹A²-, -OA²-A¹-, -OA²-C(R⁷)═C(R⁸)-, —S(O)ₙA¹-, -A¹-A⁴-, -A¹A⁴-C(R⁸)═N—N═CR⁸—, -A¹-A⁴-C(R⁸)═N—X²—X³—, -A¹-A⁴-A³-, -A¹-A⁴-N(R⁹)-, -A¹-A⁴-X—CH₂—, -A¹-A⁴-A¹-, -A¹-A⁴-CH₂X—, -A¹-A⁴-C(R⁸)═N—X²—X³—X¹—, -A¹-X—C(R⁸)═N—, -A¹-X—C(R⁸)═N—N═CR⁸—, -A¹-X—C(R⁸)═N—N(R⁹)—, -A¹-X-A⁻-X¹—, -A¹-O-A³-, -A¹-O—C(R⁷)═C(R⁸)—, -A¹-O—N(R⁹)-A²-N(R⁹)—, -A¹-O—N(R⁹)-A²-, -A¹ -N(R⁹)-A²-N(R⁹)—, -A¹-N(R⁹)-A²-, -A¹-N(R⁹)—N═C(R⁸)—, -A³-A¹-, -A⁴-A³-, -A²-NR⁹—, -A¹-A²-X¹—, -A¹-A¹-A²-X¹—, —O-A²-N(R⁹)-A²-, —CR⁷═CR⁷-A²-X¹—, —C≡C-A²-X¹—, —N═C(R⁸)-A²-X¹—, —C(R⁸)═N—N═C(R⁸)—, —C(R⁸)═N—N(R⁹), —(CH₂)₂—O—N═C(R⁸)— or —X-A²-N(R⁹)— with
n is 0, 1 or 2,
k is an integer from 1 to 9,
A¹ is —CHR⁷—,
A² is —C(═X)—,
A³ is —C(R⁸)═N—O—,
A⁴ is —O—N═C(R⁸)—,
X is O or S,
X¹ is O, S, NR⁹ or a direct bond,
X² is O, NR⁹ or a direct bond,
X³ is hydrogen, —C(═O)—, —SO₂— or a direct bond,
R⁷ which are mutually identical or different, each correspond to an optionally substituted alkyl, to a cycloalkyl or a phenyl, it being possible for each of these groups to be substituted, hydrogen, a halogen, a cyano, or an acyl;
R⁸ which are mutually identical or different, each correspond to an alkyl, an alkenyl, an alkynyl, an alkoxy, an alkylthio, it being possible for each of these groups to be substituted, a carbocyclic or heterocyclic monovalent group which may be optionally substituted, or hydrogen;
R⁹ which are mutually identical or different, each correspond to an optionally substituted alkyl, to a monovalent carbocyclic or heterocyclic group which may be optionally substituted, or to an acyl; or two R⁹ groups may form together, and with the atoms linking them, a 5-7-membered ring;
the group represented on the right side of the bond A is linked to R⁶; or -A-R⁶ and R⁵ form together with the benzene ring M, a system of optionally substituted condensed rings;
and the optional optical and/or geometric isomers, the tautomers and the addition salts with an acid or a base, which are agriculturally acceptable, of these derivatives of formula (I); and mixtures thereof; and and
(B) at least one N-cycloalkylamide compound according to formula (II) 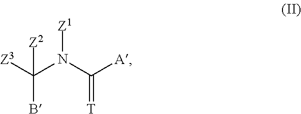
wherein:
A′ represents a carbo-linked, unsaturated or partially saturated, 5-membered heterocyclyl group that can be substituted by up to four groups R;
T represents O or S;
Z¹ represents a non-substituted C₃-C₇-cycloalkyl or a C₃-C₇-cycloalkyl substituted by up to 10 atoms or groups that can be the same or different and that can be selected in the list consisting of halogen atoms; cyano; C₁-C₈-alkyl; C₁-C₈-halogenoalkyl comprising up to 9 halogen atoms that can be the same or different; C₁-C₈-alkoxy; C₁-C₈-halogenoalkoxy comprising up to 9 halogen atoms that can be the same or different; C₁-C₈-alkoxycarbonyl; C₁-C₈-halogenoalkoxycarbonyl comprising up to 9 halogen atoms that can be the same or different; C₁-C₈-alkylaminocarbonyl; and di-C₁-C₈-alkylaminocarbonyl;
Z², Z³ which can be the same or different, represent a hydrogen atom; C₁-C₈-alkyl; C₂-C₈-alkenyl; C₂-C₈-alkynyl; cyano; nitro; a halogen atom; C₁-C₈-alkoxy; C₂-C₈-alkenyloxy; C₂-C₈-alkynyloxy; C₃-C₇-cycloalkyl; C₁-C₈-alkylsulphenyl; amino; C₁-C₈-alkylamino; di-C₁-C₈-alkylamino; C₁-C₈-alkoxycarbonyl; C₁-C₈-alkylcarbamoyl; di-C₁-C₈-alkylcarbamoyl; or N-C₁-C₈-alkyl-C₁-C₈-alkoxycarbamoyl, wherein each of these groups may be optionally substituted when chemically possible; or
Z² and Z³ together with the carbon atom to which they are linked form a substituted or non substituted C₃-C₇ cycloalkyl;
B′ represents a phenyl, naphtyl or a 5 to 10-membered monocyclic or fused bicyclic heteroaromatic ring system containing 1 to 3 heteroatoms, each heteroatom is independently selected from oxygen, nitrogen and sulphur; wherein B can be non-, mono- or polysubstituted by X′.
R′ independently represents a hydrogen atom; halogen atom; cyano; nitro; amino; sulfanyl; pentafluoro-λ-6-sulfanyl; C₁-C₈-alkylamino; di-C₁-C₈-alkylamino; tri(C₁-C₈-alkyl)silyl; C₁-C₈-alkylsulfanyl; C₁-C₈-halogenoalkylsulfanyl comprising up to 9 halogen atoms that can be the same or different; C₁-C₈-alkyl; C₁-C₈-halogenoalkyl comprising up to 9 halogen atoms that can be the same or different; C₂-C₈-alkenyl; C₂-C₈-halogenoalkenyl comprising up to 9 halogen atoms that can be the same or different; C₂-C₈-alkynyl; C₂-C₈-halogenoalkynyl comprising up to 9 halogen atoms that can be the same or different; C₁-C₈-alkoxy; C₁-C₈-halogenoalkoxy comprising up to 9 halogen atoms that can be the same or different; C₂ C₈-alkenyloxy; C₂-C₈-alkynyloxy; C₃-C₇-cycloalkyl; C₃-C₇-cycloalkyl-C₁-C₈-alkyl; C₁-C₈-alkylsulphinyl; C₁-C₈-alkylsulphonyl; C₁-C₈alkoxyimino; (C₁-C₈-alkoxyimino)-C₁-C₈-alkyl; (benzyloxyimino)-C₁-C₈-alkyl; phenoxy; benzyloxy; benzylsulfanyl; benzylamino; naphtyl; halogenophenoxy comprising up to 9 halogen atoms that can be the same or different; C₁-C₈-alkylcarbonyl; C₁-C₈-halogenoalkylcarbonyl comprising up to 9 halogen atoms that can be the same or different; C₁-C₈-alkoxycarbonyl; C₁-C₈-halogenoalkoxycarbonyl comprising up to 9 halogen atoms that can be the same or different; C₁-C₈-alkylaminocarbonyl; or di-C₁-C₈-alkylaminocarbonyl, wherein each of these groups may be optionally substituted when chemically possible;
X′ can be the same or different, represents a hydrogen atom; a halogen atom; nitro; cyano; hydroxyl; sulfanyl; amino; pentafluoro-λ6-sulfanyl; C₁-C₈-alkyl; C₁-C₈-halogenoalkyl comprising up to 9 halogen atoms which can be the same or different; C₁-C₈-alkylamino; di-C₁-C₈-alkylamino; C₁-C₈-alkoxy; C₁-C₈-halogenoalkoxy comprising up to 9 halogen atoms which can be the same or different; C₁-C₈-alkoxy-C₁-C₈-alkyl; C₁-C₈-alkylsulfanyl; C₁-C₈-halogenoalkylsulfanyl comprising up to 9 halogen atoms which can be the same or different; C₂-C₈-alkenyl; C₂-C₈-halogenoalkenyl comprising up to 9 halogen atoms which can be the same or different; C₂-C₈-alkynyl; C₂-C₈-halogenoalkynyl comprising up to 9 halogen atoms which can be the same or different C₂-C₈-alkenyloxy; C₂-C₈-halogenoalkenyloxy comprising up to 9 halogen atoms which can be the same or different; C₂-C₈-alkinyloxy; C₂-C₈-halogenoalkinyloxy comprising up to 9 halogen atoms which can be the same or different; C₃-C₇-cycloalkyl; C₃-C₇-cycloalkyl-C₁-C₈-alkyl; C₃-C₇-cycloalkyl-C₁-C₈-alkynyl; C₃-C₇-cycloalkyl-C₁-C₈-alkenyl; C₃-C₇-halogenocycloalkyl comprising up to 9 halogen atoms which can be the same or different; C₃-C₇-cycloalkyl-C₃-C₇-cycloalkyl; C₁-C₈-alkyl-C₃-C₇-cycloalkyl; formyl; formyloxy; formylamino; carboxy; carbamoyl; N-hydroxycarbamoyl; carbamate; (hydroxyimino)-C₁-C₈-alkyl; C₁-C₈-alkylcarbonyl; C₁-C₈-halogenoalkylcarbonyl comprising up to 9 halogen atoms which can be the same or different; C₁-C₈-alkylcarbamoyl; di-C₁-C₈-alkylcarbamoyl; N-C₁-C₈-alkyloxycarbamoyl; C₁-C₈-alkoxycarbamoyl; N-C₁-C₈-alkyl-C₁-C₈-alkoxycarbamoyl; C₁-C₈-alkoxycarbonyl; C₁-C₈-halogenoalkoxycarbonyl comprising up to 9 halogen atoms which can be the same or different; C₁-C₈-alkylaminocarbonyl; di-C₁-C₈-alkylaminocarbonyl; C₁-C₇-alkylcarbonyloxy; C₁-C₈-halogenoalkylcarbonyloxy comprising up to 9 halogen atoms which can be the same or different; C₁-C₈-alkylcarbonylamino; C₁-C₈-halogenoalkylcarbonylamino comprising up to 9 halogen atoms which can be the same or different; C₁-C₈-alkylaminocarbonyloxy; di-C₁-C₈-alkylaminocarbonyloxy; C₁-C₈-alkyloxycarbonyloxy, C₁-C₈-alkylsulphenyl, C₁-C₈-halogenoalkylsulphenyl comprising up to 9 halogen atoms which can be the same or different, C₁-C₈-alkylsulphinyl, C₁-C₈-halogenoalkylsulphinyl comprising up to 9 halogen atoms which can be the same or different, C₁-C₈-alkylsulphonyl, C₁-C₈-halogenoalkylsulphonyl comprising up to 9 halogen atoms which can be the same or different, C₁-C₈-alkoxyimino, (C₁-C₈-alkoxyimino)-C₁-C₈-alkyl, (C₁-C₈-alkenyloxyimino)-C₁-C₈-alkyl, (C₁-C₈-alkynyloxyimino)-C₁-C₈-alkyl, a (benzyloxyimino)-C₁-C₈-alkyl; tri(C₁-C₈-alkyl)silyl; tri(C₁-C₈-alkyl)silyl-C₁-C₈-alkyl, wherein each of these groups may be optionally substituted when chemically possible; benzyloxy which can be substituted by up to 5 groups Q′ benzylsulfanyl which can be substituted by up to 5 groups Q′ benzylamino which can be substituted by up to 5 groups Q′ aryl which can be substituted by up to 6 groups Q′ aryloxy which can be substituted by up to 5 groups Q′ arylamino which can be substituted by up to 5 groups Q′ arylsulfanyl which can be substituted by up to 5 groups Q′ aryl-C₁-C₇alkyl which can be substituted by up to 5 groups Q′ aryl-C₁-C₇alkenyl which can be substituted by up to 5 groups Q′ aryl-C₁-C₇alkynyl which can be substituted by up to 5 groups Q′ pyridinyl which can be substituted by up to four groups Q′ or pyridinyloxy which can be substituted by up to four groups Q′ aryl-C₃-C₇cycloalkyl which can be substituted by up to 5 groups Q′; or
Two vicinal substituents R′ together with the consecutive carbon atoms to which they are linked may form a 5- or 6-membered, saturated, carbo- or hetero-cycle comprising up to 3 heteroatoms, which can be substituted by up to four groups Q′ which can be the same or different and the other substituents R are as herein-described; which can be the same or different, represents a halogen atom; cyano; nitro; C₁-C₈-alkyl; C₁-C₈-alkoxy; C₁-C₈-alkylsulfanyl; C₁-C₈-halogenoalkyl comprising up to 9 halogen atoms which can be the same or different; C₁-C₈-halogenoalkoxy comprising up to 9 halogen atoms which can be the same or different; tri(C₁-C₈)alkylsilyl or tri(C₁-C₈)alkylsilyl-C₁-C₈-alkyl, wherein each of these groups may be optionally substituted when chemically possible;
as well as its salts, N-oxydes, metallic complexes, metalloidic complexes and optically active isomers.

2. Compound combination according to claim 1, wherein in the N-cycloalkylamide (B) of formula (II) is selected from the group consisting of:
a heterocycle of formula (A^{1′}) 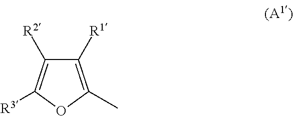
wherein:
R^{1′} to R^{3′} that can be the same or different represent a hydrogen atom; a halogen atom; C₁-C₅-alkyl; C₁-C₅-halogenoalkyl comprising up to 9 halogen atoms that can be the same or different; C₁-C₅-alkoxy or C₁-C₅-halogenoalkoxy comprising up to 9 halogen atoms that can be the same or different;
a heterocycle of formula (A^{2′}) 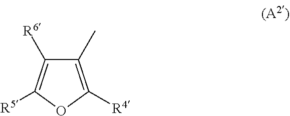
wherein:
R^{4′} to R^{6′} that can be the same or different represent a hydrogen atom; a halogen atom; C₁-C₅-alkyl; C₁-C₅-halogenoalkyl comprising up to 9 halogen atoms that can be the same or different; C₁-C₅-alkoxy or C₁-C₅-halogenoalkoxy comprising up to 9 halogen atoms that can be the same or different;
a heterocycle of formula (A^{3′}) 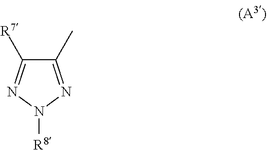
wherein:
R^{7′} represents a hydrogen atom; a halogen atom; C₁-C₅-alkyl; C₁-C₅-halogenoalkyl comprising up to 9 halogen atoms that can be the same or different; C₁-C₅-alkoxy or C₁-C₅-halogenoalkoxy comprising up to 9 halogen atoms that can be the same or different;
R^{8′} represents a hydrogen atom or a C₁-C₅-alkyl;
a heterocycle of formula (A^{4′}) 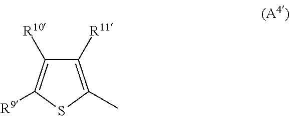
wherein:
R⁹ to R¹¹ that can be the same or different represent a hydrogen atom; a halogen atom; C₁-C₅-alkyl; amino; C₁-C₅-alkoxy; C₁-C₅-alkylsulphanyl; C₁-C₅-halogenoalkyl comprising up to 9 halogen atoms that can be the same or different or C₁-C₅-halogenoalkoxy comprising up to 9 halogen atoms that can be the same or different;
a heterocycle of formula (A^{5′}) 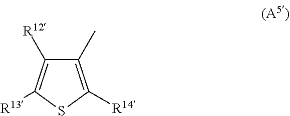
wherein:
R^{12′} and R^{13′} that can be the same or different represent a hydrogen atom; a halogen atom; C₁-C₅-alkyl; C₁-C₅-alkoxy; amino; C₁-C₅-halogenoalkyl comprising up to 9 halogen atoms that can be the same or different or C₁-C₅-halogenoalkoxy comprising up to 9 halogen atoms that can be the same or different;
R^{14′} represents a hydrogen atom; a halogen atom; C₁-C₅-alkyl; C₁-C₅-alkoxy; amino; C₁-C₅-halogenoalkyl comprising up to 9 halogen atoms that can be the same or different or C₁-C₅-halogenoalkoxy comprising up to 9 halogen atoms that can be the same or different;
a heterocycle of formula (A^{6′}) 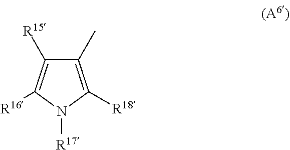
wherein:
R^{15′} represents a hydrogen atom; a halogen atom; a cyano; C₁-C₅-alkyl; C₁-C₅-alkoxy; C₁-C₅-halogenoalkoxy comprising up to 9 halogen atoms that can be the same or different or C₁-C₅-halogenoalkyl comprising up to 9 halogen atoms that can be the same or different;
R^{16′} and R^{18′} that can be the same or different represent a hydrogen atom; a halogen atom; C₁-C₅-alkoxycarbonyl; C₁-C₅-alkyl; C₁-C₅-halogenoalkoxy comprising up to 9 halogen atoms that can be the same or different or C₁-C₅-halogenoalkyl comprising up to 9 halogen atoms that can be the same or different;
R^{17′} represent a hydrogen atom or C₁-C₅-alkyl;
a heterocycle of formula (A^{7′}) 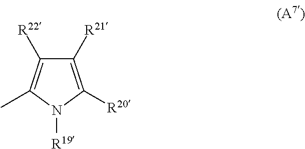
wherein:
R^{19′} represents a hydrogen atom or a C₁-C₅-alkyl
R^{20′} to R^{22′} that can be the same or different represent a hydrogen atom; a halogen atom; C₁-C₅-alkyl or C₁-C₅-halogenoalkyl comprising up to 9 halogen atoms that can be the same or different;
a heterocycle of formula (A^{8′}) 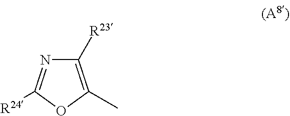
wherein:
R^{23′} represents a hydrogen atom; a halogen atom; C₁-C₅-alkyl or C₁-C₅-halogenoalkyl comprising up to 9 halogen atoms that can be the same or different;
R^{24′} represents a hydrogen atom or C₁-C₅-alkyl or C₁-C₅-halogenoalkyl comprising up to 9 halogen atoms that can be the same or different;
a heterocycle of formula (A^{9′}) 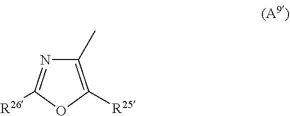
wherein:
R^{25′} represents a hydrogen atom; a halogen atom; C₁-C₅-alkyl or C₁-C₅-halogenoalkyl comprising up to 9 halogen atoms that can be the same or different;
R²⁶ represents a hydrogen atom; C₁-C₅-alkyl or C₁-C₅-halogenoalkyl comprising up to 9 halogen atoms that can be the same or different;
a heterocycle of formula (A^{10′}) 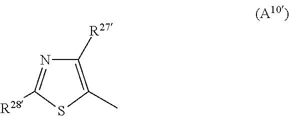
wherein:
R²⁷ represents a hydrogen atom; a halogen atom; C₁-C₅-alkyl or C₁-C₅-halogenoalkyl comprising up to 9 halogen atoms that can be the same or different;
R^{28′} represents a hydrogen atom; a halogen atom; C₁-C₅-alkyl; C₁-C₅-halogenoalkyl comprising up to 9 halogen atoms that can be the same or different; C₁-C₅-halogenoalkoxy comprising up to 9 halogen atoms that can be the same or different; amino; C₁-C₅-alkylamino or di(C₁-C₅-alkyl)amino;
a heterocycle of formula (A^{11′}) 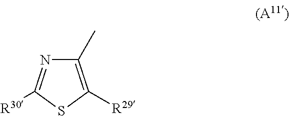
wherein:
R^{29′} represents a hydrogen atom; a halogen atom; C₁-C₅-alkyl; C₁-C₅-alkoxy; C₁-C₅-halogenoalkoxy comprising up to 9 halogen atoms that can be the same or different or C₁-C₅-halogenoalkyl comprising up to 9 halogen atoms that can be the same or different;
R^{30′} represents a hydrogen atom; a halogen atom; C₁-C₅-alkyl; C₁-C₅-halogenoalkyl comprising up to 9 halogen atoms that can be the same or different; C₁-C₅-halogenoalkoxy comprising up to 9 halogen atoms that can be the same or different; amino; C₁-C₅-alkylamino or di(C₁-C₅-alkyl)amino;
a heterocycle of formula (A^{12′}) 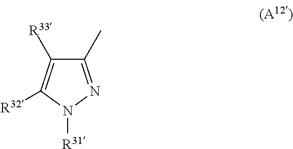
wherein:
R^{31′} represents a hydrogen atom or a C₁-C₅-alkyl
R^{32′} represents a hydrogen atom; a halogen atom; C₁-C₅-alkyl or C₁-C₅-halogenoalkyl comprising up to 9 halogen atoms that can be the same or different;
R^{33′} represents a hydrogen atom; a halogen atom; a nitro; C₁-C₅-alkyl; C₁-C₅-alkoxy; C₁-C₅-halogenoalkoxy comprising up to 9 halogen atoms that can be the same or different or C₁-C₅-halogenoalkyl comprising up to 9 halogen atoms that can be the same or different;
a heterocycle of formula (A^{13′}) 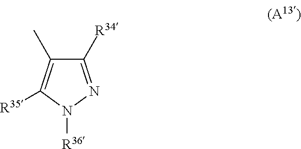
wherein:
R^{34′} represents a hydrogen atom; a halogen atom; C₁-C₅-alkyl; C3-C₅-cycloalkyl; C₁-C₅-halogenoalkyl comprising up to 9 halogen atoms that can be the same or different; C₁-C₅-alkoxy; C₂-C₅-alkynyloxy or C₁-C₅-halogenoalkoxy comprising up to 9 halogen atoms that can be the same or different;
R^{35′} represents a hydrogen atom; a halogen atom; C₁-C₅-alkyl; a cyano; C₁-C₅-alkoxy; C₁-C₅-alkylsulphanyl; C₁-C₅-halogenoalkyl comprising up to 9 halogen atoms that can be the same or different; C₁-C₅-halogenoalkoxy comprising up to 9 halogen atoms that can be the same or different; amino; C₁-C₅-alkylamino or di(C₁-C₅-alkyl)amino;
R^{36′} represents a hydrogen atom or C₁-C₅-alkyl;
a heterocycle of formula (A^{14′}) 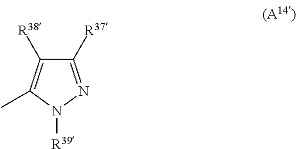
wherein:
R^{37′} and R^{38′} that can be the same or different represent a hydrogen atom; a halogen atom; C₁-C₅-alkyl; C₁-C₅-halogenoalkyl comprising up to 9 halogen atoms that can be the same or different; C₁-C₅-alkoxy or a C₁-C₅-alkylsulphanyl;
R^{39′} represents a hydrogen atom or C₁-C₅-alkyl;
a heterocycle of formula (A^{15′}) 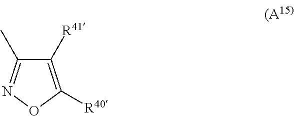
wherein:
R⁴⁰ and R⁴¹ that can be the same or different represent a hydrogen atom; a halogen atom; C₁-C₅-alkyl or C₁-C₅-halogenoalkyl comprising up to 9 halogen atoms that can be the same or different;
a heterocycle of formula (e) 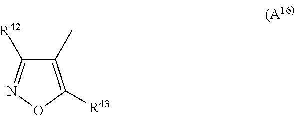
wherein:
R⁴² and R⁴³ that can be the same or different represent a hydrogen atom; a halogen atom; C₁-C₅-alkyl; C₁-C₅-halogenoalkyl comprising up to 9 halogen atoms that can be the same or different or amino;
a heterocycle of formula (A¹⁷) 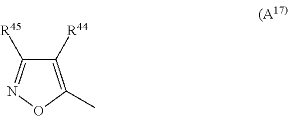
wherein:
R⁴⁴ and R⁴⁵ that can be the same or different represent a hydrogen atom; a halogen atom; C₁-C₅-alkyl or C₁-C₅-halogenoalkyl comprising up to 9 halogen atoms that can be the same or different;
a heterocycle of formula (A¹⁸) 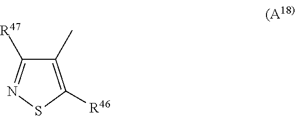
wherein:
R⁴⁷ represents a hydrogen atom; a halogen atom; C₁-C₅-alkyl or C₁-C₅-halogenoalkyl comprising up to 9 halogen atoms that can be the same or different;
R⁴⁶ represents a hydrogen atom; a halogen atom; C₁-C₅-alkyl; C₁-C₅-halogenoalkyl comprising up to 9 halogen atoms that can be the same or different or C₁-C₅-alkylsulfanyl;
a heterocycle of formula (A¹⁹) 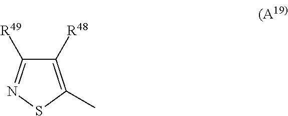
wherein:
R⁴⁹ and R⁴⁸ that can be the same or different represent a hydrogen atom; a halogen atom; C₁-C₅-alkyl; C₁-C₅-alkoxy; C₁-C₅-halogenoalkoxy comprising up to 9 halogen atoms that can be the same or different or C₁-C₅-halogenoalkyl comprising up to 9 halogen atoms that can be the same or different;
a heterocycle of formula (A²⁰) 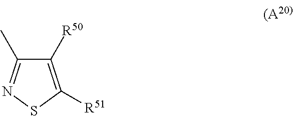
wherein:
R⁵⁰ and R⁵¹ that can be the same or different represent a hydrogen atom; a halogen atom; C₁-C₅-alkyl; C₁-C₅-alkoxy; C₁-C₅-halogenoalkoxy comprising up to 9 halogen atoms that can be the same or different or C₁-C₅-halogenoalkyl comprising up to 9 halogen atoms that can be the same or different;
a heterocycle of formula (A²¹) 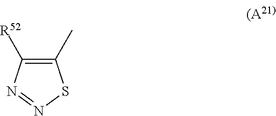
wherein:
R⁵² represents a hydrogen atom; a halogen atom; C₁-C₅-alkyl or C₁-C₅-halogenoalkyl comprising up to 9 halogen atoms that can be the same or different.
a heterocycle of formula (A²²) 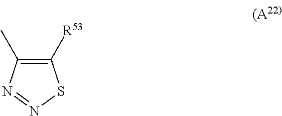
wherein:
R⁵³ represents a hydrogen atom; a halogen atom; C₁-C₅-alkyl or C₁-C₅-halogenoalkyl comprising up to 9 halogen atoms that can be the same or different.
a heterocycle of formula (A²³) 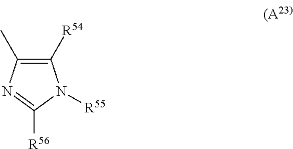
wherein:
R⁵⁴ and R56 that can be the same or different represent a hydrogen atom; a halogen atom; C₁-C₅-alkyl or C₁-C₅-halogenoalkyl comprising up to 9 halogen atoms that can be the same or different;
R⁵⁵ represents a hydrogen atom or C₁-C₅-alkyl;
a heterocycle of formula (A²⁴) 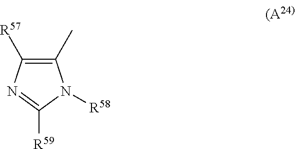
wherein:
R⁵⁷ and R⁵⁹ that can be the same or different represent a hydrogen atom; a halogen atom; C₁-C₅-alkyl or C₁-C₅-halogenoalkyl comprising up to 9 halogen atoms that can be the same or different;
R⁵⁸ represents a hydrogen atom or C₁-C₅-alkyl;
a heterocycle of formula (A²⁵) 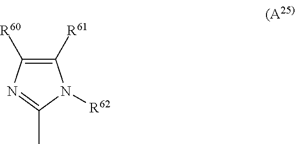
wherein:
R⁶⁰ and R⁶¹ that can be the same or different represent a hydrogen atom; a halogen atom; C₁-C₅-alkyl or C₁-C₅-halogenoalkyl comprising up to 9 halogen atoms that can be the same or different;
R⁶² represents a hydrogen atom or C₁-C₅-alkyl;
a heterocycle of formula (A²⁶) 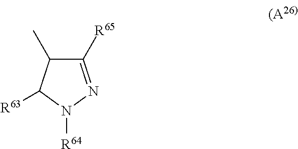
wherein:
R⁶⁵ represents a hydrogen atom; a halogen atom; C₁-C₅-alkyl; C₃-C₅-cycloalkyl; C₁-C₅-halogenoalkyl comprising up to 9 halogen atoms that can be the same or different; C₁-C₅-alkoxy; C₂-C₅-alkynyloxy or C₁-C₅-halogenoalkoxy comprising up to 9 halogen atoms that can be the same or different;
R⁶³ represents a hydrogen atom; a halogen atom; C₁-C₅-alkyl; a cyano; C₁-C₅-alkoxy; C₁-C₅-alkylsulphanyl; C₁-C₅-halogenoalkyl comprising up to 9 halogen atoms that can be the same or different; C₁-C₅-halogenoalkoxy comprising up to 9 halogen atoms that can be the same or different; amino; C₁-C₅-alkylamino or di(C₁-C₅-alkyl)amino;
R⁶⁴ represents a hydrogen atom or C₁-C₅-alkyl.

3. Combination according to claims 1 to 2 comprising mixing partners (A):(B) in a weight ratio of 1:100 to 100:1.

4. Combination according to claims 1 to 3 being a fungicidally active combination

5. A composition comprising a combination according to claims 1 to 4.

6. A composition according to claim 5 further comprising adjuvants, solvents, carrier, surfactants or extenders.

7. A method for curatively or preventively controlling the phytopathogenic fungi of plants or crops comprising the use of a fungicide composition according to claims 5 to 6 by application to the seed, the plant or to the fruit of the plant or to the soil in which the plant is growing or in which it is desired to grow.

8. The method according to claim 7 comprising applying the mixing partners (A) and (B) simultaneously or sequentially.

9. The method according to claim 7 or 8 wherein the amount of the combination of claims 1 to 6 is from 0.1 g/ha to 10 kg/ha for foliar and soil treatment and from 2 to 200 g/100 kg of seed for seed treatment.

10. Use of a combination according to any of claims 1 to 4 for the treatment of seed.

11. Use according to claim 10 for the treatment of transgenic seed.

12. Method for protecting a seed and/or shoots and foliage of a plant grown from the seed from damage by a pest or a fungus, the method comprising treating an unsown seed with a combination according to any of claims 1 to 4.

13. Method according to claim 12, wherein the seed is treated with component (A) at the same time that it is treated with component(s) (B).

14. Method according to claim 12, wherein the seed is treated with component (A) at a different time than it is treated with component(s) (B).

15. Seed that has been treated with a combination according to any of claims 1 to 4.
